(19) United States
(12) Patent Application Publication
(10) Pub. No.: US 2014/0090295 A1
(43) Pub. Date: Apr. 3, 2014

(54) CULTIVATION POD

(71) Applicant: FAMGRO FARMS, Carlsbad, CA (US)

(72) Inventor: Steve FAMBRO, Carlsbad, CA (US)

(73) Assignee: FAMGRO FARMS, Carlsbad, CA (US)

(21) Appl. No.: 13/835,910

(22) Filed: Mar. 15, 2013

Related U.S. Application Data
(60) Provisional application No. 61/709,111, filed on Oct. 2, 2012.
(60) Provisional application No. 61/709,114, filed on Oct. 2, 2012.
(60) Provisional application No. 61/709,116, filed on Oct. 2, 2012.
(60) Provisional application No. 61/709,105, filed on Oct. 2, 2012.
(60) Provisional application No. 61/709,110, filed on Oct. 2, 2012.
(60) Provisional application No. 61/709,115, filed on Oct. 2, 2012.
(60) Provisional application No. 61/709,120, filed on Oct. 2, 2012.

(51) Int. Cl. A01G 31/02

(52) U.S. Cl. CPC A01G 31/02
USPC 47/62 N

(57) ABSTRACT

A cultivation pod includes a platform, a nutrient supply system, and light-emitting diodes (LEDs). The platform includes a supporting tray comprising channels, each having a nutrient-film, and a plant carrier positioned on the supporting tray, where the plant carrier lies in a plane when positioned on the supporting tray and is removable in a direction that lies in the plane without removing the supporting tray from the pod. The nutrient supply system feeds nutrient media to the supporting tray and the plant carrier is removable from the pod without disconnecting the nutrient supply system from the supporting tray. The LEDs provide light to the plant carrier when the plant carrier is positioned on the supporting tray, where the LEDs lie in a planar orientation and are unevenly distributed in the substantially planar orientation.

### CROSS-REFERENCE TO RELATED APPLICATIONS

This application claims the benefit of U.S. Provisional Application No. 61/709,105, filed Oct. 2, 2012, U.S. Provisional Application No. 61/709,110, filed Oct. 2, 2012, U.S. Provisional Application No. 61/709,111, filed Oct. 2, 2012, U.S. Provisional Application No. 61/709,114, filed Oct. 2, 2012, U.S. Provisional Application No. 61/709,115, filed Oct. 2, 2012, U.S. Provisional Application No. 61/709,116, filed Oct. 2, 2012, and U.S. Provisional Application No. 61/709,120, filed Oct. 2, 2012, the disclosure of each of which is incorporated by reference herein in its entirety.

### BACKGROUND

The present disclosure relates generally to the field of hydroculture, and in particular to the field of hydroponic systems for plant cultivation.

Food production methods have undergone little change in the 40 years since Norman Borlaug's “Green Revolution.” Borlaug's methods—using higher-yield crops, increasing irrigation, introducing more fertilizer, and spraying pesticides—allowed some traditionally arid regions, such as Mexico, to become net crop-exporters.

The efficacy of Borlaug's methods, however, is limited. For example, the methods have not translated well to the Middle East and North African regions, where water scarcity and deficient soils have proved too challenging.

Some have tried using greenhouses and/or traditional hydroponic systems to improve agricultural production in problematic regions, but these too have their limits. For example, such food production methods require significant labor costs and still suffer from the limited availability of necessary resources, such as water.

Even in regions suitable to bountiful plant growth, population and environmental factors have limited harvests. As populations and urban areas expand, tillable areas contract. Reduced tillable areas causes over-harvesting, resulting in reduced quality and quantity.

In some regions, such as Korea and Japan, the scarcity of land results in little or no tillable regions. The result is expensive importation of fruits and plants. Further, imported produce can never achieve the freshness of locally-grown produce.

The prior art solutions to land scarcity is problematic. Such methods require high labor costs, are not space-efficient, and typically generate low quality produce.

### BRIEF SUMMARY

The presently disclosed embodiments are directed to solving one or more of the problems presented in the prior art, as well as providing additional features that will become readily apparent by reference to the following detailed description when taken in conjunction with the accompanying drawings.

In a first example, a cultivation pod comprises a platform, a nutrient supply system, and light-emitting diodes (LEDs). The platform includes a supporting tray comprising channels, each having a nutrient-film, and a plant carrier positioned on the supporting tray, where the plant carrier lies in a plane when positioned on the supporting tray and is removable in a direction that lies in the plane without removing the supporting tray from the pod. The nutrient supply system feeds nutrient media to the supporting tray and the plant carrier is removable from the pod without disconnecting the nutrient supply system from the supporting tray. The LEDs provide light to the plant carrier when the plant carrier is positioned on the supporting tray, where the LEDs lie in a planar orientation and are unevenly distributed in the substantially planar orientation. The cultivation pod may beneficially reduce the volume needed for harvest, improve automation capabilities, and increase efficient use of resources. The cultivation may also be self-contained, providing all the environmental parameters needed for cultivation, thereby allowing for large harvests in urban areas.

In a second example, the cultivation pod of the first example further comprises a vertical bellows that feeds air radially into the cultivation pod. In a third example, the vertical bellows of the second example creates a planar air flow. In a fourth example, the vertical bellows of any of the second or third examples comprises holes positioned less than or equal to 0.05 to 45 centimeters above a top of the plant carrier when the plant carrier is on the supporting tray. By directing air under the leaves, the pods may beneficially increase plant absorption of carbon dioxide.

In a fifth example, each channel of any of the first through fourth examples is defined by a pair of ribs and a height of each rib above a bottom of the channel is less than or equal to 0.65 cm centimeters above an upper surface of the supporting tray.

In a sixth example, the nutrient supply system of any of first through fifth examples feeds nutrient media to a rear portion of the supporting tray, the nutrient media flows along an upper surface of the supporting tray to provide the nutrient film, and the nutrient media falls vertically from a front portion of the supporting tray. In a seventh example, the nutrient media of the sixth example flows from the front portion of the supporting tray to a rear portion of the supporting tray. In an eight example, the nutrient media of the seventh example flows on a lower surface of the supporting tray when the nutrient media flows from the front portion of the supporting tray to the rear portion of the supporting tray.

In a ninth example, the supporting tray of any of the first through eight examples comprises a front edge that permits removal of the plant carrier in the plane.

In a tenth example, the plant carrier of any of the first through ninth examples has a surface area comprising substantially equal width and length.

In an eleventh example, the cultivation pod of any of the first through tenth examples includes reflective surfaces in an internal space of the cultivation pod.

In a twelfth example, a cultivation pod includes a platform, and the platform includes a supporting tray and a plant carrier positioned on the supporting tray. The plant carrier lies in a plane when positioned on the supporting tray, is removable in a direction that lies in the plane, and is removable without removing the supporting tray from the pod.

In a thirteenth example, the supporting tray of the twelfth example includes channels having a nutrient-film. In a fourteenth example, the channels of the thirteenth example are each defined by a pair of ribs and a height of each rib above a bottom of the channel is less than or equal to 0.65 centimeters.

In a fifteenth example, the cultivation pod of any of the twelfth through fourteenth examples includes a nutrient supply system that feeds nutrient media to the supporting tray and the plant carrier is removable from the pod without disconnecting the nutrient supply system from the platform. In a sixteenth example, the nutrient supply system of the fifteenth example feeds nutrient media to a rear portion of the supporting tray, the nutrient media flows along an upper surface of the supporting tray to provide a nutrient film, and the nutrient media falls vertically from a front portion of the supporting tray. In a seventeenth example, the nutrient media of the sixteenth example flows from the front portion of the supporting tray to a rear portion of the supporting tray. In an eighteenth example, the nutrient media of the seventeenth example flows on a lower surface of the supporting tray when the nutrient media flows from the front portion of the supporting tray to the rear portion of the supporting tray.

In a nineteenth example, the supporting tray of any of the twelfth through eighteenth examples includes a front edge that permits removal of the plant carrier in a single plane.

In a twentieth example, the plant carrier of any of the twelfth through nineteenth examples has a surface area comprising substantially equal width and length.

In a twenty-first example, the cultivation pod of any of the twelfth through twentieth examples includes a vertical bellows that feeds air radially into the cultivation pod. In a twenty-second example, the vertical bellows of the twenty-first example creates a planar air flow. In a twenty-third example, the vertical bellows of the twenty-first or twenty-second examples includes holes positioned less than or equal to 0.05 to 45 centimeters above a top of the plant carrier when the plant carrier is on the supporting tray.

In a twenty-fourth example, the cultivation pod of any of the twelfth through twenty-third examples includes LEDs that provide light to the plant carrier when the plant carrier is positioned on the supporting tray, where the LEDs lie in a substantially planar orientation relative to the plant carrier and are unevenly distributed in the substantially planar orientation. In a twenty-fifth example, the cultivation pod of any of the twelfth through twenty-fourth examples includes reflective surfaces in an internal space of the cultivation pod.

In a twenty-sixth example, a cultivation pod comprises boundary structures (wherein the boundary structures are configured to define an internal space of the cultivation pod), a first platform within the internal space of the cultivation pod, a light distribution system configured to distribute light to the first platform, a liquid nutrient distribution system configured to distribute liquid nutrient to the first platform, and an air distribution system configured to distribute air to the first platform.

In a twenty-seventh example, an internal space of the first twenty-sixth examples comprises a reflective surface.

In a twenty-eight example, the light distribution system of the twenty-seventh example includes LEDs arranged in a substantially planar orientation that is orthogonal to the orientation of the reflective surface. In a twenty-ninth example, the LEDs of the twenty-eight example are unevenly distributed in the substantially planar orientation. In a thirtieth example, the LEDs of any of twenty-eight and twenty-ninth examples are arranged in regions.

In a thirty-first example, the pod of any of the first through thirtieth examples comprise LEDs in a first region more densely spaced than LEDs in a second region, wherein the first region is closer to the reflective surface than the second region.

In a thirty-second example, the LEDs of any of the first through thirty-first examples are arranged in four quadrants, wherein at least one quadrant comprises six rows and ten columns of LEDs, wherein the positioning of each of the six rows is characterized as a percentage of a depth of the at least one quadrant, wherein the positioning of each of the ten columns is characterized as a percentage of a width of the quadrant, wherein the first row is positioned at 5% of the depth, wherein the second row is positioned at 14% of the depth, wherein the third row is positioned at 25% of the depth, wherein the fourth row is positioned at 40% of the depth, wherein the fifth row is positioned at 55% of the depth, wherein the sixth row is positioned at 72% of the depth, wherein the first column is positioned at 4% of the width, wherein the second column is positioned at 10% of the width, wherein the third column is positioned at 23% of the width, wherein the fourth column is positioned at 38% of the width, wherein the fifth column is positioned at 45% of the width, wherein the sixth column is positioned at 55% of the width, wherein the seventh column is positioned at 62% of the width, wherein the eighth column is positioned at 77% of the width, wherein the ninth column is positioned at 90% of the width, and wherein the tenth column is positioned at 96% of the width.

In a thirty-third example, the light distribution system of any of the twenty-sixth through thirty-second examples further comprises a pod positioning system, wherein the pod positioning system is configured to reposition the pod in accordance with movement of an external source of light.

In a thirty-fourth example, the pod of any of first through thirty-third examples comprises a second platform within the internal space, wherein a portion of the light distribution system is positioned between the second platform and the first platform.

In a thirty-fifth example, an air distribution system of any of the first through thirty-fourth examples includes vertical bellows.

In a thirty-sixth example, an air distribution system of any of the first through thirty-fifth examples includes a wind system or fan system to create air flow.

In a thirty-seventh example, an air distribution system of any of the first through thirty-sixth examples spreads air radially over the platforms.

In a thirty-eighth example, an air distribution system of any of the first through thirty-seventh examples generates planar air flow.

In a thirty-ninth example, an air distribution system of any of the first through thirty-eighth examples includes an air filter, e.g., a sub-micron High-Efficiency Particulate Air (HEPA) filter.

In a fortieth example, an air distribution system of any of the first through thirty-ninth examples provides additional CO2 to enhance plant growth.

In a forty-first example, an internal space of any of the first through fortieth examples is insulated from an outside environment. In a forty-second example, the cultivation pod of the forty-first example includes a positive air pressure inside the pod.

In a forty-third example, the pod of any of the first through forty-second examples includes a mechanism to improve air flow.

In a forty-fourth example, the pod of any of the first through forty-third examples includes a thermal control of outside air coming into the cultivation pod, where the control is integrated into an air distribution system. In a forty-fifth example, the internal space of the forty-fourth example is directly connected to the outside air.

In a forty-sixth example, a liquid nutrient distribution system of any of the first through forty-fifth examples includes a nutrient delivery manifold.

In a forty-seventh example, a liquid nutrient distribution system of any of the first through forty-sixth examples includes a reservoir for liquid nutrient. In a forty-eighth example, the reservoir of the forty-seventh example is positioned outside of the cultivation pod. In a forty-ninth example, the reservoir of any of the forty-seventh and forty-eight examples feeds more than one cultivation pod.

In a fiftieth example, a liquid nutrient distribution system of any of the first through forty-ninth examples includes reservoirs for the liquid nutrient. In a fifty-first example, the reservoirs of the fiftieth example are located on each platform of the cultivation pod.

In a fifty-second example, a liquid nutrient of any of the first through fifty-first examples is periodically replenished from a master supply. In a fifty-third example, the master supply of the fifty-second example is controlled by a computer program.

In a fifty-fourth example, the pod of any of the first through fifty-third examples includes an additional mechanism to modify flow rates of the liquid nutrient.

In a fifty-fifth example, the liquid nutrient of any of the first through fifty-fourth examples flows continuously. In a fifty-sixth example, the liquid nutrient of any of the twenty-sixth through fifty-fourth examples flows intermittently.

In a fifty-seventh example, the pod of any of the first through fifty-sixth examples includes a computer program to control a flow rate of liquid nutrient.

In a fifty-eighth example, a flow rate of liquid nutrient in any of the first through fifty-seventh examples is 1-3 liters/minute per row of plants.

In a fifty-ninth example, the liquid nutrient of any of the first through fifty-eighth examples is adjusted for temperature, pH, or oxygenation.

In a sixtieth example, an oxygenation level of the liquid nutrient in any of the first through fifty-ninth examples is adjusted to suit the growth condition of the plants. In a sixty-first example, the oxygenation level of the sixtieth example is adjusted by adjusting the height of the waterfall, materials used for the tray and/or the ribs, etc.

In a sixty-second example, the cultivation pod of any of the first through sixty-first examples includes a computer system for controlling and monitoring an environmental parameter such as temperature, lighting, humidity, flow rate, wind speed, nutrient and/or pH level of the liquid nutrient, growth or fungi, bacteria, algae, etc.

In a sixty-third example, the cultivation pod of the sixty-second example includes a seeding system. In a sixty-fourth example, the seeding system of the sixty-third example includes pipettes. In a sixty-fifth example, a pipette of the sixty-fourth example distributes a seed within a medium.

In a sixty-sixth example, the cultivation pod of any of the first through sixty-fifth examples includes a master nutrient supply for replenishing the liquid nutrient of multiple cultivation pods.

In a sixty-seventh example, two or more cultivation pods of any of the first through sixty-sixth examples have the same environmental parameters. In a sixty-eighth example, two or more cultivation pods of any of the first through sixty-seventh examples have different environmental parameters. In a sixty-ninth example, a cultivation pod of any of the first through sixty-eight examples has different environmental parameters within the pod. In a seventieth example, a platform of the sixty-ninth example has different environmental parameters within the platform.

In a seventy-first example, a cultivation pod of any of the first through seventieth examples has the same plant species throughout the pod. In a seventy-second example, a cultivation pod of any of the first through seventy-first examples has different plant species.

In a seventy-third example, a cultivation pod of any of the first through seventy-second examples has an automatic platform distribution system. In a seventy-fourth example, the automatic platform distribution system of the seventy-third example includes a robotic arm that removes or replaces one or more of the plant carrier and the tray.

In a seventy-fifth example, a cultivation pod of any of the first through seventy-fourth examples has a plant growth monitoring system. In a seventy-sixth example, the plant growth monitoring system of the seventy-fifth example includes an automatic sensor to determine plant growth. In a seventy-seventh example, the automatic sensor of the seventy-sixth example is a Light Detection And Ranging sensor. In a seventy-eighth example, the automatic sensor of the seventy-sixth example includes a system for image or color analysis to determine plant growth. In a seventy-ninth example, plant growth in any of the seventy-fifth through seventy-eighth examples is used to deduce efficacy of nutrient ratios. In an eightieth example, the efficacy of nutrient ratios in the seventy-ninth example is used to modify the liquid nutrient supplied to the plant. In an eighty-first example, plant growth in any of the seventy-fifth through eightieth examples is used to modify the environmental parameters of the pod.

In an eighty-second example, a cultivation pod of any of the first through eighty-first examples includes a tracking system to trace a plant through the entire cultivation process. In an eighty-third example, a plant in the eighty-second example is identified from seed to packaging using a unique identifier. In an eighty-fourth example, the unique identifier of the eighty-third example is provided by a bar code or a radio-frequency identification (RFID) tag. In an eighty-fifth example, the unique identifier of any of the eighty-third and eighty-fourth examples is used to record all the information in regard to the cultivation of the plant including species, time, location or environmental parameters used.

In an eighty-sixth example, the internal space of the pod of any of the first through eighty-fifth examples includes an air-sealed environment. In an eighty-seventh example, the internal space of the pod of any of the first through eighty-sixth examples is sealed from contaminants from the outside environment.

In an eighty-eighth example, the cultivation pod of any of the first through eighty-seventh examples includes a covered opening. In an eighty-ninth example, the cover of the eighty-eighth example is opened by a door, such as a zipper, a roll-up door, a sliding door, a magnetically sealed door, etc.

In a ninetieth example, the internal space of any of the first through eighty-ninth examples is light-sealed. In a ninety-first example, the internal space of any of the first through eighty-ninth examples is light-permeable.

In a ninety-second example, one or more platforms of the first through ninety-first examples are cantilevered.

In a ninety-third example, at least two platforms of the first through ninety-second examples are arranged vertically to allow liquid nutrient to flow from an upper platform to a lower platform.

In a ninety-fourth example, one or more platforms of the first through ninety-third examples comprise a tray. In a ninety-fifth example, the tray of the ninety-fourth example is sloped from back to front to achieve optimal flow rate, velocity and/or volume of the liquid nutrient. In a ninety-sixth example, an upper surface of the tray of the ninety-fifth example is sloped at about 1.5-2 degrees to the horizontal.

In a ninety-seventh example, one or more platforms of the first through ninety-sixth examples include an upper tray, a lower tray and a middle tray. In a ninety-eighth example, the upper tray and lower tray of the ninety-seventh examples are sloped from back to front and from front to back, respectively, to achieve optimal flow rate, velocity and/or volume of the liquid nutrient. In a ninety-ninth example, the upper tray and lower tray of the ninety-eight example are sloped at about 1.5-2 degrees to the horizontal.

In an one hundredth example, an upper platform and a lower platform of any of the first through ninety-ninth examples are connected by a waterfall. In an one hundred and first example, liquid nutrient in the one hundredth example flows from a tray to the waterfall through a connecting channel. In an one hundred and second example, liquid nutrient in the one hundredth example flows from an upper tray to a lower tray and to the waterfall. In an one hundred and third example, the liquid nutrient of any of the one hundredth through one hundred and second examples is oxygenated by the turbulence at the intersection between the connecting channel or lower tray and the waterfall, and/or at the bottom of the waterfall. In an one hundred and fourth example, the waterfall of any of the one hundredth through one hundred and third examples is located at the back and/or side of the platforms. In an one hundred and fifth example, the waterfall of any of the one hundredth through one hundred and fourth examples comprises a tubular channel that allows the liquid nutrient to flow through.

In an one hundred and sixth example, liquid nutrient in any of the first through one hundred and fifth examples has an oxygen concentration of about 8-12 ppm.

In an one hundred and seventh example, a tray, upper tray, lower tray and/or waterfall of any of the first through one hundred and sixth examples includes a material and/or physical feature that increases turbulence. In an one hundred and eighth example, a tray, upper tray, lower tray and/or waterfall of any of the first through one hundred and seventh examples includes a material and/or physical feature that reduces splashing. In an one hundred and ninth example, a tray, upper tray, lower tray and/or waterfall of any of the first through one hundred and eight examples includes a physical feature that improves nutrient flow. In an one hundred and tenth example, the physical feature of the one hundred and ninth example includes a rib. In an one hundred and eleventh example, a tray, upper tray, lower tray and/or waterfall of any of the first through one hundred and tenth examples includes a physical feature that reduces algae growth.

In an one hundred and twelfth example, a pod of any of the first through one hundred and eleventh examples includes a heat source and/or air conditioner.

In an one hundred and thirteenth example, a pod of any of the first through one hundred and twelfth examples includes a humidifier.

In an one hundred and fourteenth example, a pod of any of the first through one hundred and thirteenth examples includes a CO2 source.

In an one hundred and fifteenth example, a pod of any of the first through one hundred and fourteenth examples includes a system for monitoring mold and/or fungus growth.

In an one hundred and sixteenth example, a pod of any of the first through one hundred and fifteenth examples includes a light distribution controller configured to adjust the wavelength of light in the pod.

In an one hundred and seventeenth example, a pod of any of the first through one hundred and sixteenth examples includes a lighting cooling system configured to reduce the temperature of electronics associated with a light distribution system.

In an one hundred and eighteenth example, the cooling system of the one hundred and seventeenth example includes distilled water circulated in tubing, wherein the distilled water absorbs heat emitted from the electronics.

In an one hundred and nineteenth example, the cooling system of the one hundred and eighteenth example includes a heat exchanger, vapor phase, or heat sink to reduce the temperature of the distilled water, wherein energy extracted from the water is discarded or reused in the system. In some examples, the temperature of the distilled water is kept below or equal to 70° F.

In an one hundred and twentieth example, a light distribution system of any of the first through the one hundred and nineteenth examples includes a heat shield between the electronics and the first platform.

In an one hundred and twenty-first example, the heat shield of the one hundred and twentieth example includes a Mylar coating with paper air gap.

In an one hundred and twenty-second example, a pod of any of the first through one hundred and twenty-first examples includes an air circulation system configured to pass air over the electronics.

In an one hundred and twenty-third example, the air circulation system of the one hundred and twenty-second example includes a heat exchanger to reduce the temperature of circulated air, wherein energy extracted from the circulated air is discarded and/or reused in the system.

In an one hundred and twenty-fourth example, a light distribution system of any of the first through the one hundred and twenty-third examples include a pod positioning system, wherein the pod positioning system is configured to reposition the pod in accordance with movement of an external source of light.

In an one hundred and twenty-fifth example, a light distribution system of any of the first through the one hundred and twenty-fourth examples includes a fiber optic system configured to channel external light to the internal space of the cultivation pod.

In an one hundred and twenty-sixth example, the fiber optic system of the one hundred and twenty-fifth example includes a Fresnel lens configured to separate visible light from infrared light.

In an one hundred and twenty-seventh example, the fiber optic system of the one hundred and twenty-sixth example includes a first channel for channeling the visible light to the internal space of the cultivation pod and a second channel for channeling the infrared light away from the internal space of the cultivation pod.

In an one hundred and twenty-eighth example, the second channel of the one hundred and twenty-seventh example channels the infrared light to an energy recuperation system.

In an one hundred and twenty-ninth example, a light distribution system of any of the first through the one hundred and twenty-eight examples includes a plurality of red LEDs and a plurality of blue LEDs.

In an one hundred and thirtieth example, the plurality of red LEDs and the plurality of blue LED of the one hundredth and twenty-ninth example are in a ratio of 4 red LEDs to each blue LED.

In an one hundred and thirty-first example, the pod of the one hundred and twenty-ninth or one hundred and thirtieth examples includes a first light distribution controller configured to selectively activate one or more of the plurality of LEDs, wherein the first light distribution controller is further configured to adjust a ratio of active red LEDs to active blue LEDs.

In an one hundred and thirty-second example, a plurality of LEDs any of the first through one hundred and thirty-first examples comprises a plurality of red LEDs, a plurality of blue LEDs, a plurality of royal blue LEDs, and a plurality of white LEDs.

In an one hundred and thirty-third example, the pod of the one hundred and thirty-second example wherein the plurality of red LEDs, the plurality of white LEDs, the plurality of blue LEDs, and the plurality of royal blue LED are in a ratio of 6 red LEDs to 2 white LEDs to 1 blue LED to 0.5 royal blue LEDs.

In an one-hundred and thirty-fourth example, the pod of the one-hundred and thirty-second example or one hundred and thirty-third example further comprising a second light distribution controller configured to selectively activate one or more of the plurality of LEDs, wherein the second light distribution controller is further configured to adjust a ratio of active red LEDs to active white LEDs to active blue LEDs to active royal blue LEDs.

In an one-hundred and thirty-fifth example, the pod of any of the first through one hundred and thirty-fourth examples further comprising a third light distribution controller configured to adjust the wavelength of the distributed light.

In an one-hundred and thirty-sixth example, the pod of any of the first through one hundred and thirty-fifth examples further comprising a pod positioning system, wherein the pod positioning system is configured to reposition the pod in accordance with movement of an external source of light.

In an one hundred and thirty-seventh example, no soil is used in the pods of any of the first through hundred and thirty-sixth examples. In an one hundred and thirty-eighth example, soil is used in the pods of any of the first through hundred and thirty-sixtheighth examples.

Any of the above examples may be embodied in a method of achieving the associated functionalities and benefits.

### BRIEF DESCRIPTION OF THE FIGURES

FIG. 1A illustrates an exemplary cultivation pod with platforms visible within.

FIG. 1B illustrates the cultivation pod of FIG. 1A with an additional boundary structure covering the front of the pod.

FIG. 2A illustrates an exemplary pair of platforms in accordance with one example.

FIG. 2B shows an exploded view of the plant carrier and supporting tray of FIG. 2A.

FIG. 2C illustrates the pair of platforms of FIG. 2A, but with the flow of liquid nutrient highlighted for explanatory purposes

FIG. 3A illustrates a portion of a supporting tray from a rear view.

FIG. 3B illustrates another rear view of a upper supporting tray.

FIG. 4A illustrates an exemplary pair of supporting trays.

FIG. 4B illustrates a side view of the pair of supporting trays of FIG. 4A.

FIG. 5A illustrates a perspective view of one example of a pair of supporting trays.

FIG. 5B illustrates a top view of the arrangement of FIG. 5A.

FIG. 5C illustrates an underside view of the arrangement of FIG. 5A.

FIG. 6A illustrates a perspective view of one example of a pair of supporting trays.

FIG. 6B illustrates a top view of the arrangement of FIG. 6A.

FIG. 6C illustrates an underside view of the arrangement of FIG. 6A.

FIG. 7 illustrates an exemplary arrangement of LEDs in a substantially planar orientation.

FIG. 8 illustrates an exemplary cultivation pod with a transparent ceiling.

FIG. 9 illustrates an exemplary cultivation pod with an exemplary air distribution system having vertical bellows.

FIG. 10 illustrates a cultivation pod with an exemplary air distribution system with horizontal bellows.

### DETAILED DESCRIPTION

Described herein are cultivation pods and associated methods of harvesting. The cultivation pods may include one or more attributes designed to reduce the volume needed for harvest, improve automation capabilities, and increase efficient use of resources. The pods may include a platform with a plant carrier and supporting tray, a light distribution system, a liquid nutrient distribution system, and an air distribution system.

The volume required to produce each plant can be important in space-limited areas. For example, arable land may be scarce or non-existent in densely populated areas. Importing produce can be expensive and can lower the freshness of for-sale produce. Beneficially, the cultivation pods described herein may reduce the volume necessary to grow produce and allow for large-scale plant growth in urban areas. For example, the stackable, compact, and self-contained cultivation pods described herein can be efficiently stored in warehouses

The pods may reduce their volume in a number of ways. For example, some pods reduce the space between a plant and an overhead light-source, thereby reducing the overall height of the pod. When a pod has many vertically stacked growing platforms, the savings per platform quickly accumulate. Reducing the height of the pod reduces fabrication costs (smaller pods require less materials), reduces storage space (smaller pods can be more densely stacked), reduces labor costs (smaller pods requires less vertical movement to retrieve plants), and increases the feasibility of an automated cultivation system (smaller pods requires less vertical transport of automated equipment).

Labor is a large portion of the cost of cultivation. Automating a plant cultivation system would greatly reduce costs. Some of the cultivation pods described herein may simplify the removal of plants, thereby increasing the feasibility of automation. For example, cultivation pods may be configured to remove plant carriers from their platforms without disconnecting nutrient supply. Cultivation pods may also include plant carriers which are removable from their platforms in a single direction, thereby reducing the complexity of removal equipment.

In addition to increasing the feasibility of automating the system, the above aspects of the cultivation pods described here also reduce labor costs. For example, the time required to harvest a plant is greatly reduced by removing the plants without disconnecting the water supply. Time is also reduced when plant carriers may be moved in only one direction to remove them from the pod.

Cultivation pods described here may also reduce the need for resources, such as water and energy. For example, liquid nutrient levels on the platforms may be reduced. Lower liquid nutrient film levels means less equipment is required to circulate and maintain the nutrient. Thus, the cultivation pods described here may be more sustainable then the prior art cultivation systems.

Conditions in the pod may be optimized to save water and other resources associated with plant cultivation, and enhance plant growth. The pods may beneficially limit or remove the need for pesticides and may provide flexibility in environmental conditions. In some embodiments, one or more of the foregoing features are incorporated into a single device.

The cultivation pods may include a boundary structures that create an internal space within the cultivation pod. The pods may have platforms within the internal space, a light distribution system configured to distribute light to the one or more platforms, a liquid nutrient distribution system configured to distribute liquid nutrient to the one or more platforms, and an air distribution system configured to distribute air to the one or more platforms. Some cultivation pods may include one or more of the foregoing features. In some pods, at least two platforms are arranged vertically to allow liquid nutrient to flow from the upper platform to the lower platform.

In methods of cultivating a plant in a pod, a plant carrier is removed from the pod in a plane, wherein the plant carrier lies in the plane when positioned on a supporting tray during plant growth. In another method, a plant carrier is removed from a cultivation pod without removing a supporting tray from the pod. Some methods allow a plant carrier to be removed from a cultivation pod without disconnecting a nutrient supply system.

In some methods of illuminating a cultivation pod, LEDs are arranged in a planar orientation in the pod and are unevenly distributed in the substantially planar orientation. The LEDs may be configured to provide a uniform wavefront at a predetermined distance from the LEDs.

In some methods of distributing air in a cultivation pod, vertical bellows are arranged to provide air to the underside of plants positioned within the pod. In some further methods, holes are located in the bellows at a predetermined height above a plant carrier.

### Cultivation Pod

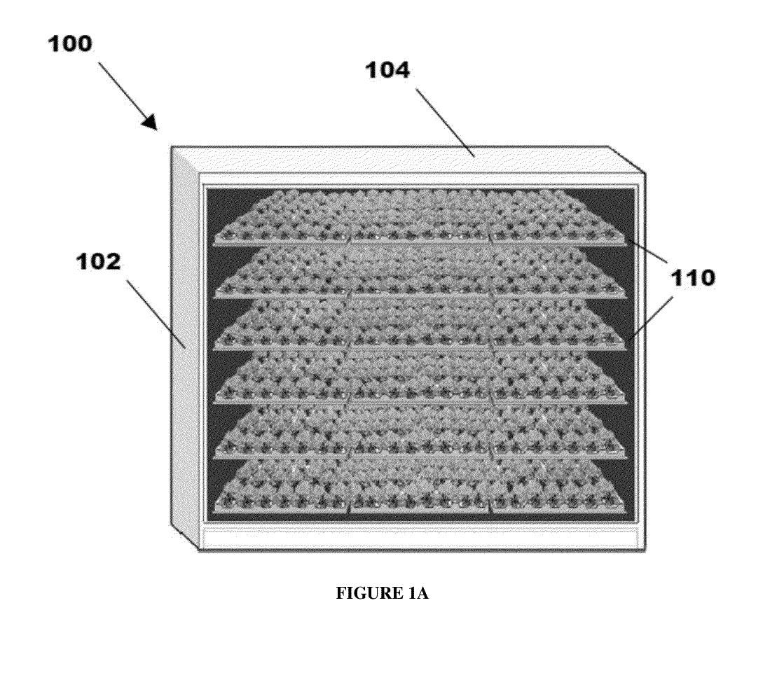

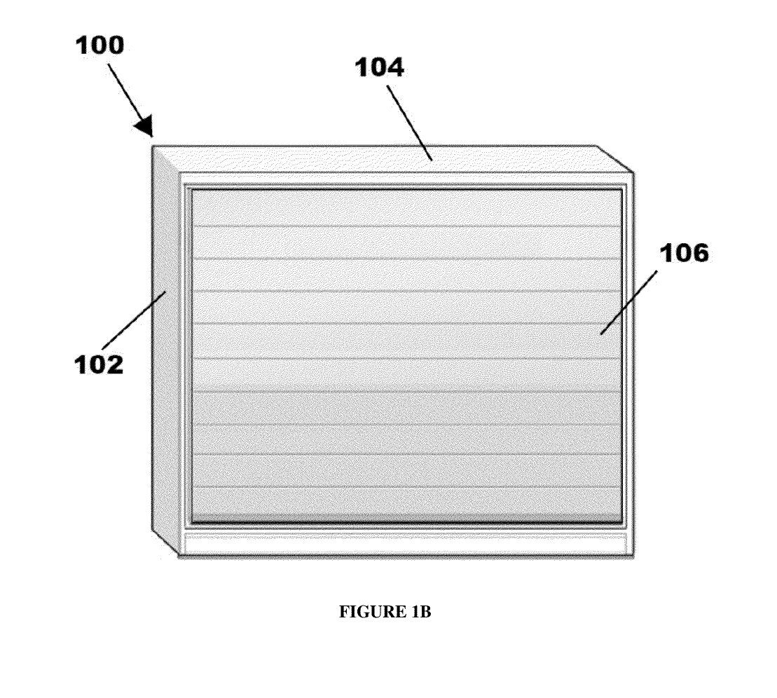

This disclosure now turns to a description of the general structures of a cultivation pod, with descriptions of other features (e.g., light distribution and liquid nutrient distribution) to follow. FIG. 1A illustrates an exemplary cultivation pod 100 with platforms 110 visible within. Cultivation pod 100 includes boundary structures 102 and 104. Additional boundary structures may be present in cultivation pod 100. The boundary structures define an internal space of the cultivation pod 100, in which the platforms 110 are placed. Cultivation pod 100 may include a light distribution system (not shown), an air distribution system (not shown), and a liquid nutrient distribution system (not shown).

FIG. 1B illustrates the cultivation pod of FIG. 1A with an additional boundary structure 106 covering the front of the pod. Boundary structure 106 is illustrated as a roll-up door, but may comprise any of the covers described herein. Boundary structure 106 may facilitate access to the internal space of the cultivation pod 100.

As used herein, a cultivation pod can be understood to be any chamber that comprises a plurality of boundary structures, wherein the boundary structures are configured to define an internal space of the cultivation pod. The boundary structures may be (but are not limited to) one or more of a wall, a ceiling, a door, a window, and a floor. The pods may be completely enclosed by the boundary structures, so that the internal space is sealed. In other embodiments, the pod is open to the outside atmosphere, such as through an open ceiling or an opening that allows external air to enter the pod and/or internal air to exit the pod.

The boundaries may be constructed of any material that is suitable for plant growth, such as metal, plastic, wood, etc., or a combination of several materials. The materials may be suitable for insulation of the internal space of the cultivation pod from the outside environment, such as light, temperature, air, moisture, etc. In other embodiments, the materials may be permeable for some aspect of the outside environment, such as light, temperature, air, moisture, etc. For example, the boundaries may be non-permeable to light, so that the cultivation pod is light sealed. The boundaries may also be transparent to light, so that the cultivation pod may utilize natural lighting for photosynthesis.

One of the boundaries may be an opening, so that seeds and/or plants may be added to and/or removed from the cultivation plant. The opening may comprise a zipper, a roll-up door, a sliding door, a magnetically sealed door, etc., for easy access to the internal space of the cultivation pod.

Any suitable shapes and/or dimensions for the cultivation pod may be used, and the shape may be optimized for the handling and operation of the cultivation pod and the plants being cultivated. For example, the shapes and/or dimensions of the cultivation pod may be adapted for plant carrier handling, warehouse operation, transportation efficiency, human/machinery manipulation, etc. The shapes and/or dimensions of the cultivation pod may be adapted for home and/or industrial uses. In some embodiments, the pod is a convex polyhedron, such as a rectangular cuboid, but the pod need not assume a recognized geometry.

Specific diameters of the cultivation pod may be limited only by the need of planar light generation. (See description of Light Emitting Diodes below.) In some embodiments, the pod is sized to fit within a warehouse and in some further embodiments the pod is sized to ensure transportation within a cargo container. In other embodiments, the pod is sized to fit within a kitchen, approximating the size of a refrigerator, for example. The dimensions of the pod may be 12 ft.×12 ft.×4 ft.

### Platforms

One or more platforms may be positioned within the internal space of the cultivation pod. The platform may include a plant carrier and a supporting tray. The plant carrier may hold the plants in position and may be located above or sit on top of the supporting tray. In some embodiments, the plant carrier does not make contact with the supporting tray. The supporting tray may receive liquid nutrient and provide a nutrient film under the roots of the plants in the plant carrier.

To reduce space necessary for plant growth, the platforms may be vertically stacked, as illustrated above in FIG. 1A. As used herein, “vertically stacked” can be understood to refer to two or more platforms in a generally vertical orientation. The platforms need not be horizontal and, indeed, the supporting trays may be sloped to promote flow of liquid nutrient. The platforms need not be directly positioned over one another.

The platforms may be configured to allow removal of the plant carrier without removing the supporting tray. This may greatly simplify the removal of plants from the pod. For example, a liquid nutrient system can remain in place when the plants are inserted to and removed from the pod. That is, the liquid nutrient system need not be disconnected and reconnected when the plants are harvested and introduced. Further, removing only a plant carrier reduces the energy required to harvest the plant. In prior art devices, removal of plants from a greenhouse or hydroponic system typically requires either removing the plants individually or removing the plants with the reservoir of water feeding the roots.

The supporting trays may be beneficially configured so that the plant carriers can be removed in one axis. That is, the plant carriers may lie on or above the supporting tray and are removable from that position in a single direction. In this way, a laborer or an automated system need not move the plant carrier in multiple directions to remove it from the cultivation pod. In some embodiments, the plant carrier may be situated on rails, tracks, or other devices to promote removal in a single direction. By allowing for removal in a single direction, pod height may be reduced because the plant carrier need not need be lifted up—requiring more clearance between plant and the above platform—before being removed.

The plant carriers may have a surface area of substantially equal width and length. This may allow the plants to be removed more efficiently by a laborer or an automated system.

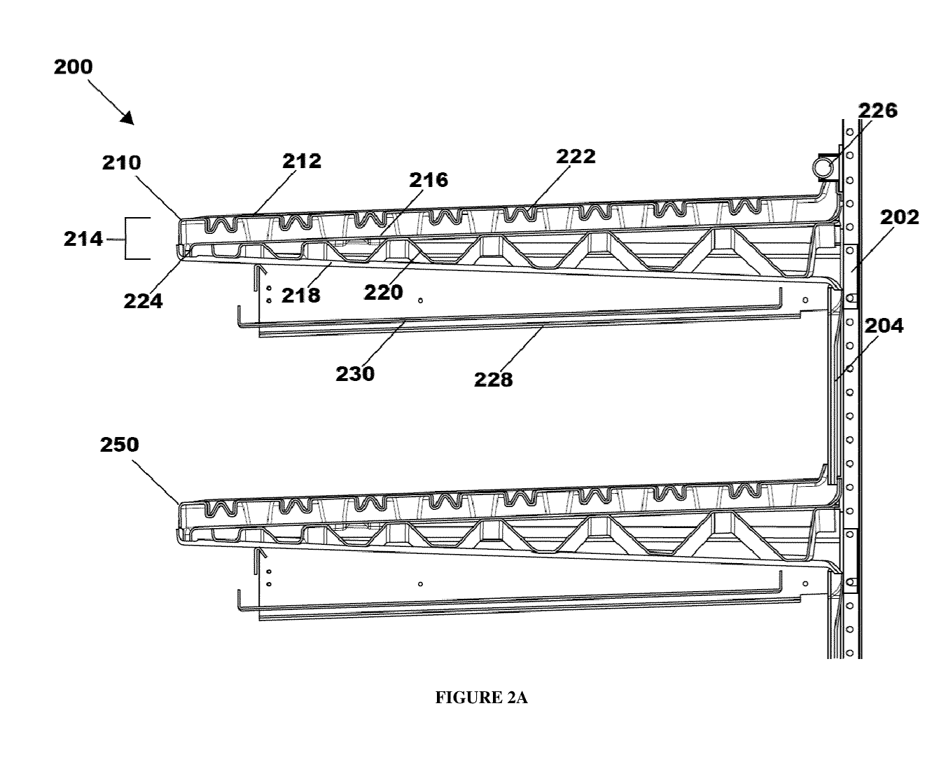

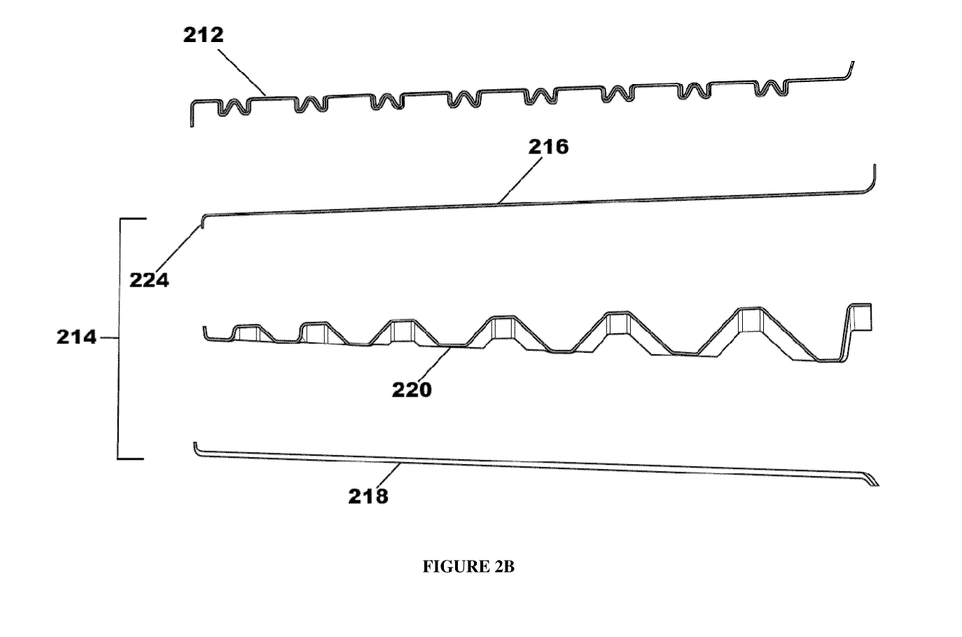

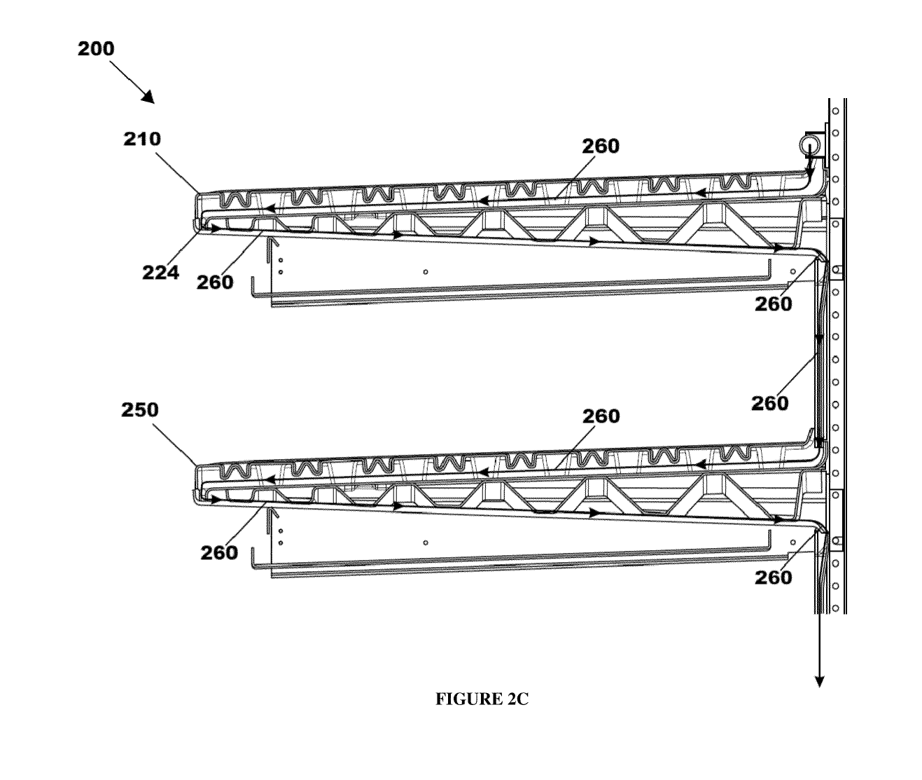

FIG. 2A illustrates a pair 200 of platforms 210 and 250 in accordance with one example. The platforms are coupled to a pod via the side wall 202. Side wall 202 may be a boundary structure of the pod, or may be a structure within the pod configured to anchor the supporting trays. Platforms 210 and 250 are connected by a tubular waterfall 204.

Upper platform 210 and lower platform 250 may have similar features. For simplicity, the following describes upper platform 210, but it should be understood that the description could equally apply to lower platform 250.

Upper platform 210 includes a plant carrier 212 and a supporting tray 214. The supporting tray 214 includes an upper tray 216, a middle tray 218, and a lower tray 220. FIG. 2B shows an exploded view of plant carrier 212 and supporting tray 214.

Plant carriers 212 include recesses 222 for receiving plants. The upper tray 216 includes a flow of liquid nutrient on its surface (see liquid nutrient flow 260 in FIG. 2C) that feeds the roots of plants in recesses 222. Upper tray 216 receives liquid nutrient from manifold 226. As can be seen in FIG. 2A, the plant carrier can be removed in the a direction of the plane in which it lies. In this embodiment, the front edge of the platform is configured to prevent interference with the plant carrier as it is removed. In this embodiment, there is no lip or other retaining structure that prevents removal in one direction.

The upper tray may be sloped for gravitational flow of liquid nutrient from the rear of the cultivation pod to the front. The liquid nutrient flows over an edge 224 at the end of upper tray 216 and on to the lower tray 220.

The lower tray 220 includes a flow of liquid nutrient on its surface (see flow 260 in FIG. 2C). The lower tray may be sloped for gravitational flow of liquid nutrient from the front of the cultivation pod to the rear. The flow feeds the tubular channel 204 at the rear of the pod.

The middle tray 218 rests on the lower tray 220 and provides support for the upper tray 216. Because the upper and lower trays are sloped in opposite directions, the middle tray 218 may assume a triangular side profile, such as the wedge-like shape in FIGS. 2A-C.

Note that supporting tray 214 is one example of a supporting tray, and others are contemplated. For example, additional supporting trays are discussed below.

Support arm 228 may be fixed to the cultivation pod structure and provide support for the lower tray of the platform. A further support 230 may be provided for a light distribution system (not shown).

The distance between the platforms can be adjusted so that one or more light sources of the light distribution system may be positioned at a predetermined distance from the tops of the plants. In some embodiments, the distance is approximately 18 inches. In some embodiments, the platforms are separated by about 4 inches.

In some embodiments, at least 1, 2, 3, 4, 5, 10, 20, 50 or more platforms are included in the cultivation pod. In some embodiments, the cultivation pod may comprise 18 platforms, which may be arranged as 3 columns of 6. The dimensions of the platform are determined to facilitate handling, manually and/or mechanically, and by the dimensions of the cultivation pod. In some embodiments, a platform may comprise a plant carrier and one or more trays, as described in more detail below. In some embodiments, the platforms may comprise rounded corners in the front of the plant carrier or tray to facilitate plant removal and/or laminar flow of a liquid nutrient. In some embodiments, the platform is cantilevered, with its back fixed on a frame. In some embodiments, the platform is supported by a hanger.

In some embodiments, the one or more platforms are sized so that an arrangement of platforms almost completely occupies a horizontal plane within the cultivation pod, thereby beneficially increasing the horizontal growth density of plants grown within the pod. In some embodiments, the depth and width of the one or more platforms are characterized as a percentage of the internal depth and width, respectively, of a cultivation pod. In some embodiments, the depth of the one or more platforms is 95%, 96%, 97%, 98%, 99%, and 100% of the internal depth of the pod. In some embodiments, the width of the one or more platforms is 96%, 97%, 98%, 99%, and 100% of the internal width of the cultivation pod. Multiple platforms may be arranged in a horizontal plane within the cultivation pod. In some further embodiments, n platforms are arranged in a horizontal plane within the cultivation pods and the width of the one or more platforms is 96/n %, 97/n %, 98/n %, 99/n %, and 100/n % of the internal width of the cultivation pod. In some embodiments, a platform is 42 inches wide.

In some embodiments, the one or more platforms are one or more of a shelf or a floor. As used herein, a shelf can be understood to include a platform that is elevated above the floor of a cultivation pod. In further embodiments, one or more platforms may be removable. A platform may be configured to receive one or more plants for growth within the cultivation pod. In some embodiments, a platform is configured to receive plants at different stages of growth, such as the seedling-stage or the mature-stage, for example.

The plant carrier may be a plate with structural features that allow the plants to be fixed in a specific position. Spacing of such structural features may vary according to the specific needs of plant species. Other structural features for the plant carrier may include holes, slits or channels that allow interaction between the roots of the plants and the liquid nutrient. In some embodiments, structural features such as ridges or columns may be introduced to the plant carrier to ensure proper spacing between the plant carrier and the platform. In some embodiments, the plant carrier may comprise a structural feature at the back that serves as a transition point for the flow of liquid nutrient, and helps to reduce splashing when the liquid falls on the surface of the upper tray. In some embodiments, the structural feature may comprise a splash guard which fits the lower end of the waterfall. In some embodiments, the feature may be incorporated into one or more trays, or into the cultivation pod. Preferably, such spacing should allow optimal interaction between the roots of the plants and the liquid nutrient. In some embodiments, the spacing may allow a pressed fit between the roots of the plants and the surface of the platform.

Any suitable material that will retain its integrity when in the environment of the cultivation pod for a prolonged period of time may be used for the plant carrier. Weight and cost are among the other concerns when choosing a material for the plant carrier. For example, aluminum may be used to manufacture the plant carrier for its resistance to rust, light weight, and relatively low cost. Materials that are photo-reflective, and thus can maximize the light efficiency of the light distribution system, are also contemplated.

FIG. 2C illustrates the pair 200 of platforms (210, 250) of FIG. 2A above, but with the flow of liquid nutrient highlighted for explanatory purposes. The flow of liquid nutrient exits a manifold and falls on to the upper platform 200. The liquid then flows along the upper tray and falls to the lower tray off an edge 224 of the upper tray.

By falling off the edge 224 of the upper tray, the laminar flow on the upper tray may become turbulent. This turbulence causes mixing and entrainment of air from the cultivation pod. This entrainment and mixing of air oxygenates the liquid nutrient. Oxygenation is important to the liquid nutrient because it prevents algae growth. Prior art systems typically oxygenate artificially, that is, prior art nutrient supply system typically include a module for oxygenating the liquid supply system. The pods described herein oxygenate using the structural features of the supporting trays. Further stages of oxygenation are described below.

The liquid nutrient may fall vertically from the edge of the upper tray and land on the lower tray. Both the vertical fall and impact with the lower tray mixes and entrains more air, thereby further oxygenating the liquid nutrient. The liquid nutrient then flows along the lower tray and over an edge of the lower tray. The liquid nutrient then enters another waterfall before landing on the upper tray of the platform below. As with the transition from the upper tray to the lower tray, the transition from the lower tray to the upper tray of the platform below entrains air when the liquid nutrient leaves the edge, falls vertically, and impacts the tray below.

The upper and lower trays may be sloped at about 0.5, 1, 1.5, 2, 3, 5, 10, 15, 20, 25, 30 or more degrees to the horizontal. In some pods, the tray of each platform is sloped at about 1.5-2 degrees to the horizontal.

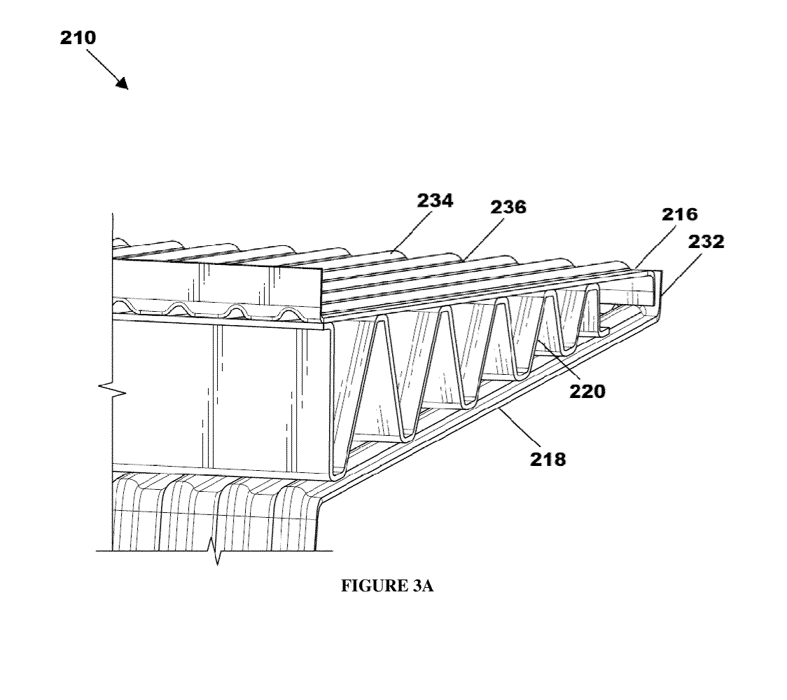

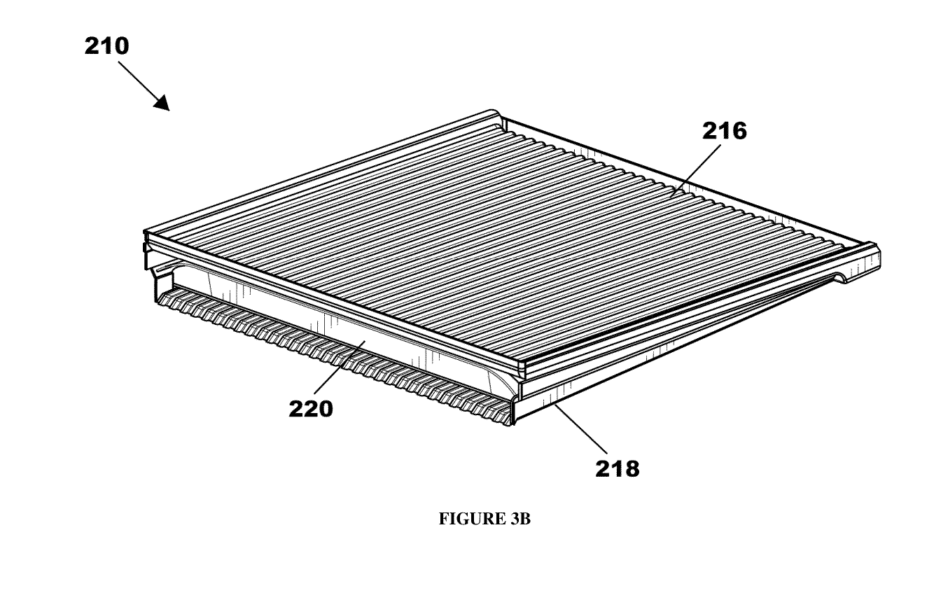

The upper and lower trays may include ribs to guide the flow of liquid nutrient. FIG. 3A illustrates the supporting tray 210 from a rear view. Ribs 234 can be seen on the upper tray 216 and lower tray 218. The ribs may be dimensioned so that the height of the liquid nutrient is reduced. Each pair of ribs may define a channel 236. The ribs may be 0.65 centimeters in height above a bottom of the channel. On other trays, the ribs may be less than 0.65 centimeters in height above the bottom of the channel, including 0.05, 0.10, 0.15, 0.20, 0.25, 0.30, 0.35, 0.40, 0.45, 0.50, 0.55, or 0.60. In some trays, the ribs are a height other than those listed here.

Lowering the level of the liquid nutrient on the supporting tray may beneficially reduce the cost of construction and require less circulation equipment. Further, the lower weight may reduce the strain on automated equipment when removing and installing the trays.

As illustrated in FIG. 3A, lower tray 218 may have a front edge 232 that prevents splashing. The front edge of the platform may be configured so that it does not prevent removing a plant carrier in the plane in which the plant carrier lies. That is, the plant carrier can be removed in a single direction.

The upper tray may be configured so that liquid nutrient flows in a channel and then drops off the front edge 224. With a large number of channels, the simple transition from upper tray to lower tray may provide a large amount of oxygenation to the liquid nutrient.

FIG. 3B illustrates a perspective view of upper supporting tray 210, again from the rear.

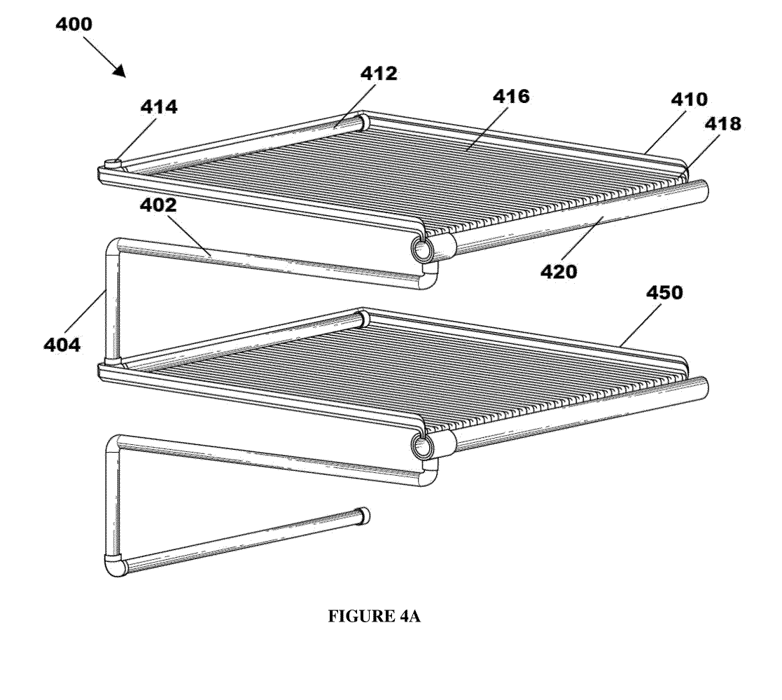

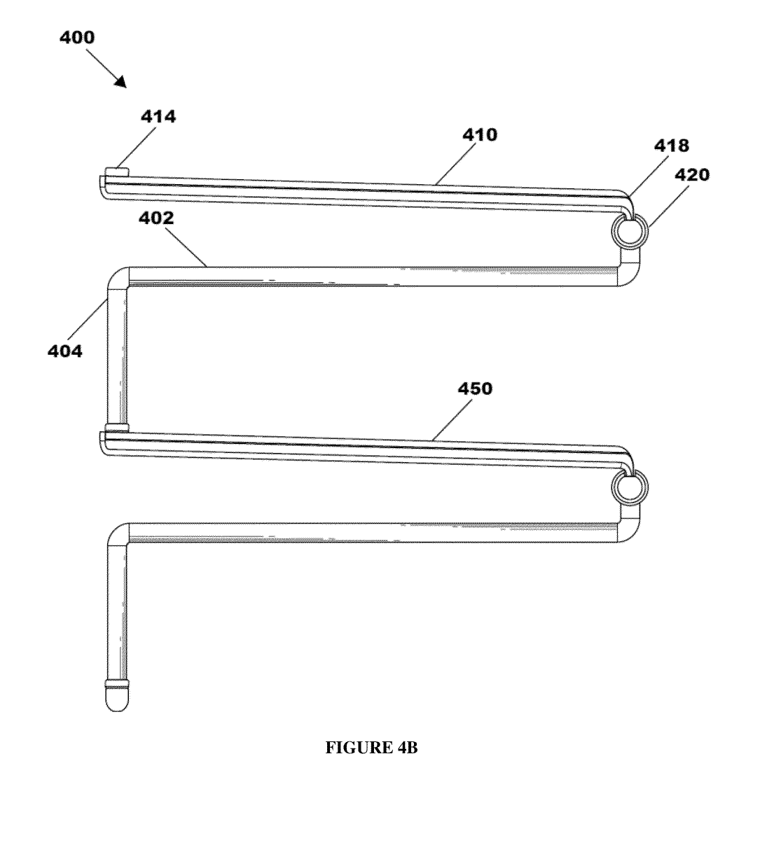

FIG. 4A illustrates a pair 400 of supporting trays. Upper supporting tray 410 is connected to lower supporting tray 450 through a tubular channel 402 that includes a waterfall 404. Supporting trays 410 and 450 may each be constructed as an integral unit and thus possess structural simplicity, provide for convenient maintenance, provide for uniform liquid distribution, provide for low fabrication cost, and be of low weight, for example.

Upper platform 410 and lower platform 450 may have similar features. For simplicity, the following describes upper platform 410, but it should be understood that the description could equally apply to lower platform 450.

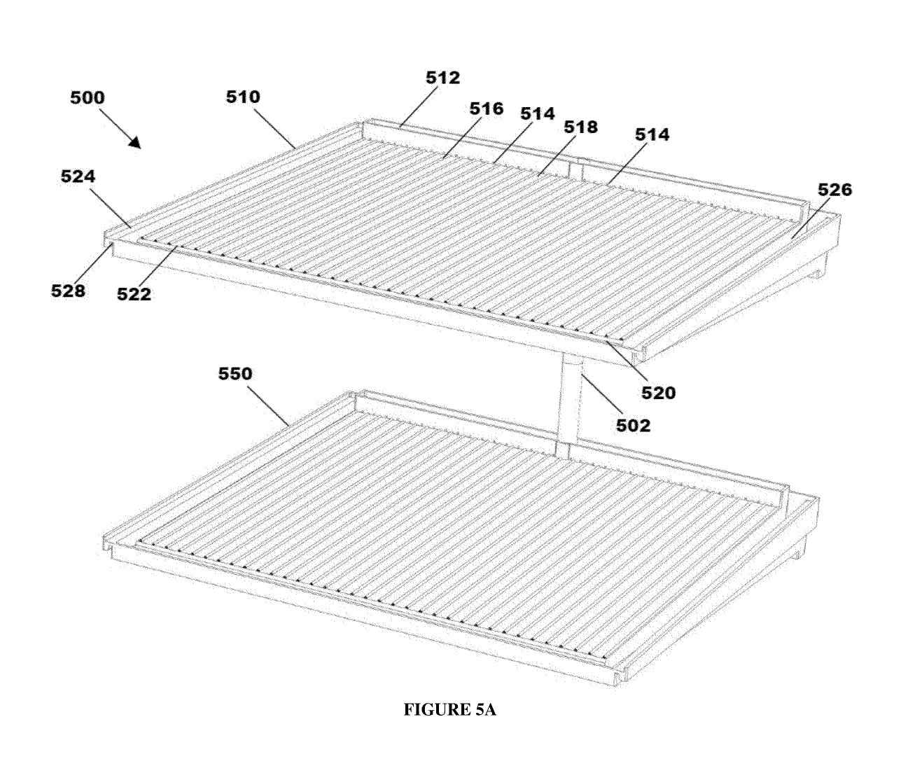

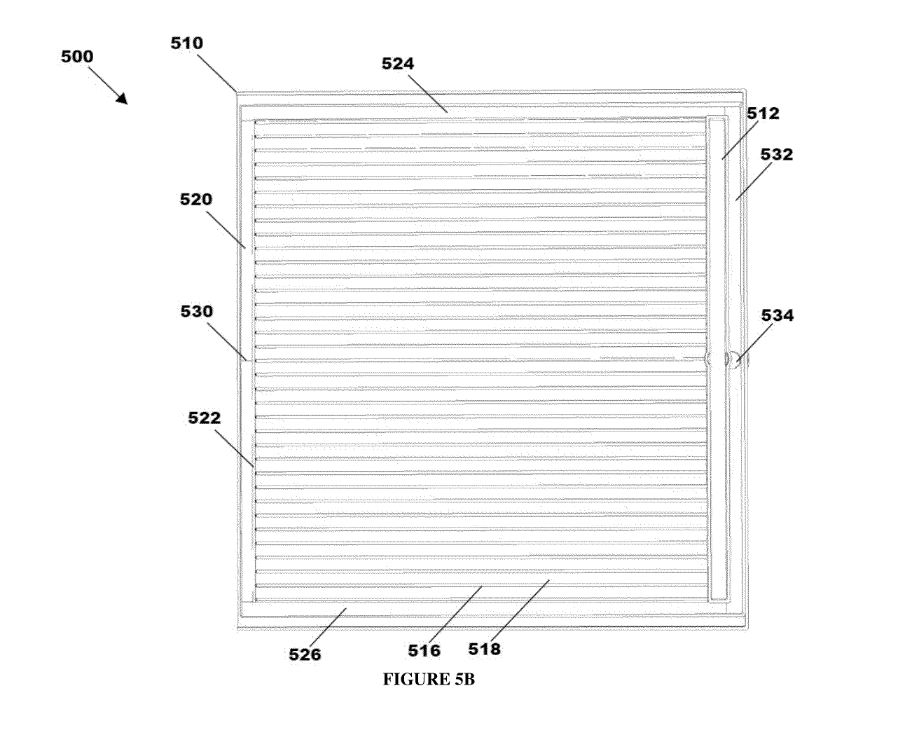

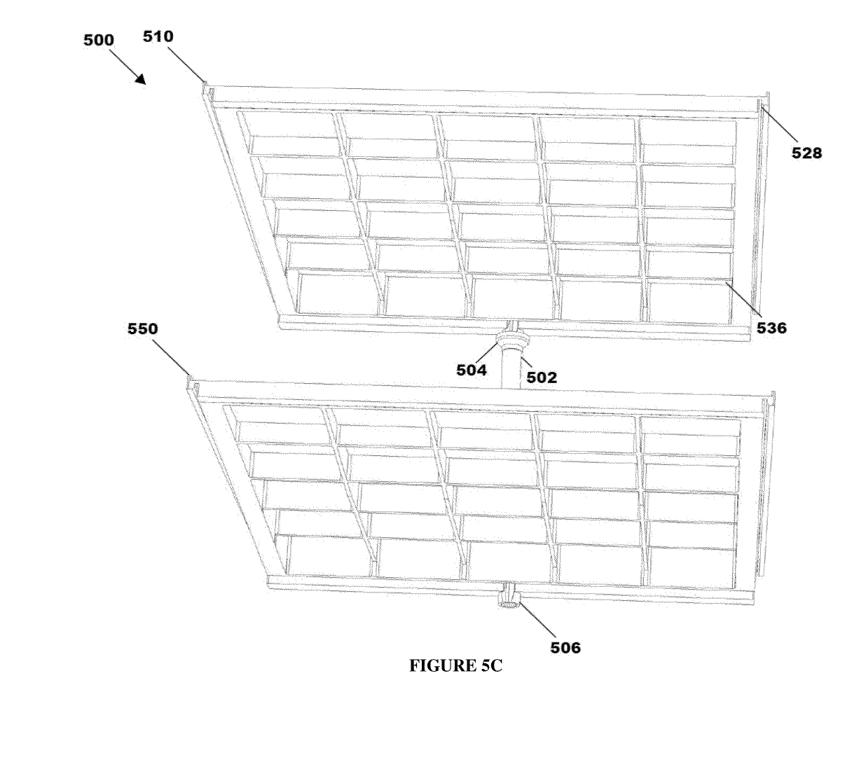

Liquid nutrient is supplied to supporting tray 410 through aperture 414. From aperture 414, the liquid nutrient flows along feeding tube 412. Feeding tube 412 includes apertures (not shown) that control the flow of liquid nutrient from feeding tube 412 to the upper surface 416 of supporting tray 410 (see description of apertures with respect to FIG. 5A below).

Upper surface 416 may include ribs to guide the liquid nutrient through channels and over a front edge 418. As the liquid nutrient flows over front edge 418 and collects in front channel 420, the nutrient is oxygenated.

From front channel 420, the liquid nutrient flows through tubular channel 402 and through the waterfall 404. The liquid nutrient is further oxygenated as it flows through waterfall 404. The liquid nutrient then feeds into a feeding tube of lower supporting platform 450.

FIG. 4B illustrates a side view of the pair 400 of supporting trays described above with respect to FIG. 4A.

FIG. 5A illustrates a perspective view of one example of a pair 500 of supporting trays 510 and 550. The supporting trays are connected by a waterfall in the form of tubular channel 502. Each supporting tray 510 and 550 may be constructed as an integral unit and have structural simplicity, convenient maintenance, uniform liquid distribution, low fabrication cost, and low weight, for example.

Upper supporting tray 510 and lower supporting tray 550 have similar features. However, it will be understood that a pair of supporting trays may have dissimilar features, or may be connected to supporting trays with different features. For explanatory purposes, only upper supporting tray 510 is described in detail below, but it should be understood that the description could equally apply to lower platform 550.

Upper supporting tray 510 includes feeding channel 512 that collects liquid nutrient supplied from another supporting tray or directly from a liquid nutrient supply manifold. The feeding channel includes apertures 514 that permit liquid nutrient to be released onto the upper surface of the supporting tray. Apertures 514 may be sized to provide a controlled flow rate of liquid nutrient to the tray. That is, the flow rate through the apertures may allow liquid nutrient to build in the feeding channel, thereby ensuring that all apertures receive liquid nutrient and ensuring a uniform flow of liquid nutrient feeds the channels of the supporting tray.

For some trays, the diameter of the apertures may be determined by calculating an appropriate flow rate through the hole to maintain a predetermined height of liquid nutrient in the channel. For example, if a height above the apertures is predetermined and the flow rate from the above tray (or manifold) is known, then the diameter of the apertures can be calculated so that the height above the apertures is maintained for the known flow rate of liquid nutrient. If the height of the liquid nutrient is less than the predetermined height, then the flow rate through the apertures is lower, allowing the height in the channel to increase. If the height of the liquid nutrient in the channel is greater than the predetermined height, than the flow rate in the tubes is greater, allowing the height to decrease. In some variations, the apertures may be 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, or 7.5 mm diameter, or any diameter in between. In some variations, the diameter of the apertures may be different than the foregoing.

The upper surface of supporting tray 510 includes a number of channels 518 defined by a plurality of ribs 516. The liquid nutrient flows through the apertures 514 and along the channels 518. The upper surface of the supporting tray 510 is sloped from back to front, allowing the liquid nutrient to flow down the upper surface toward the front edge 522. A plant carrier (now shown) may sit above the upper surface, providing plant roots with access to the flow of liquid nutrient in the channels. As described above, as the liquid nutrient passes over front edge 522, the nutrient is oxygenated. Also, as the nutrient falls to and impacts the front channel (see FIG. 5B below) it is further oxygenated.

The front channel receives liquid from the front edge 522 and feeds it to two side channels 524 and 526. The liquid nutrient then feeds into a rear channel with an aperture that feeds into tubular channel 502. Although two side channels are shown in FIG. 5A, it is understood that a single side channel could be used. Further, the channel(s) need not run along the side, but could run underneath the supporting surface. In such supporting trays, lateral space may be saved by eliminating the perimeter area of the side channels and such space could be used to grow more plants or reduce the width of the pod.

Upper supporting tray 510 may also include a lip 528. Lip 528 may be used for secure coupling of the supporting tray in the pod.

FIG. 5B illustrates a top view of the arrangement of FIG. 5A (note that lower supporting tray 550 is obscured in this view by upper supporting tray 510). Clearly visible in FIG. 5B is the front channel 520 and rear channel 532. Front channel 520 has a division point 530 that separates the direction flow of liquid nutrient in the channel. Liquid below this point (as viewed in FIG. 5B) flows to side channel 526 because the front channel 520 is sloped toward that channel below the division point 530. By contrast, liquid above the division point 530 flows toward side channel 524. Rear channel 532 includes aperture 534 for the liquid to flow to the tubular channel 502 and to lower supporting tray 550.

FIG. 5C illustrates an underside view of the arrangement of FIG. 5A. The underneath of each supporting tray may be configured to provide a stable base but also to reduce the weight of the platform. For example, the underside of upper supporting tray 510 is constructed of spines 536 that provide lightweight stability for the supporting tray.

Tubular channel 502 may include a connector 504 at the upper edge for connecting the channel to the supporting tray. A corresponding connector 506 can be seen on the bottom of lower supporting tray 550.

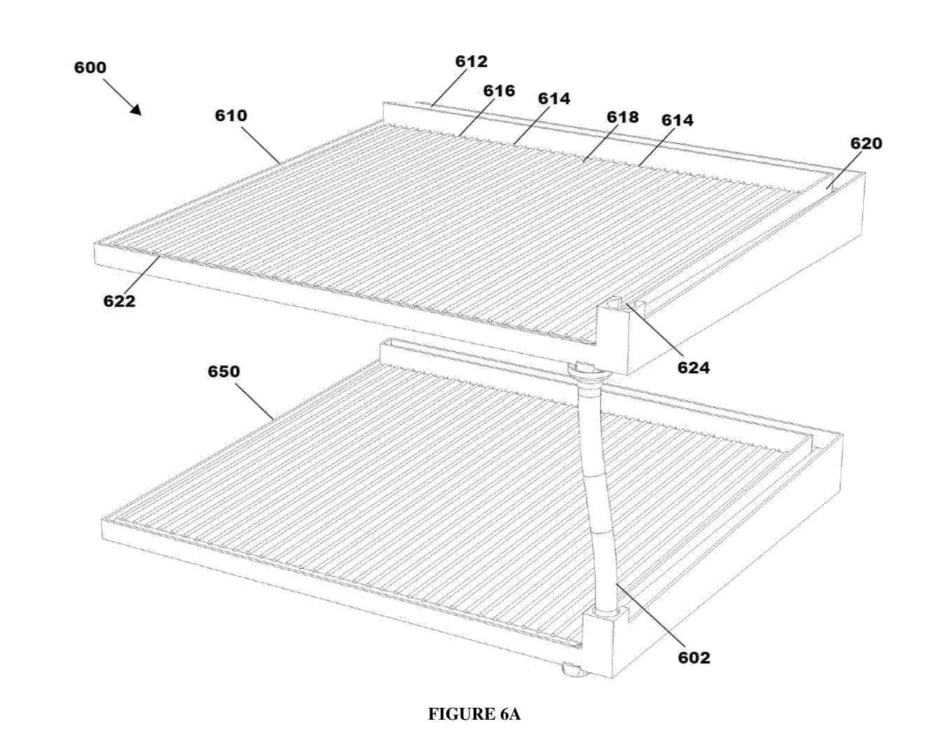

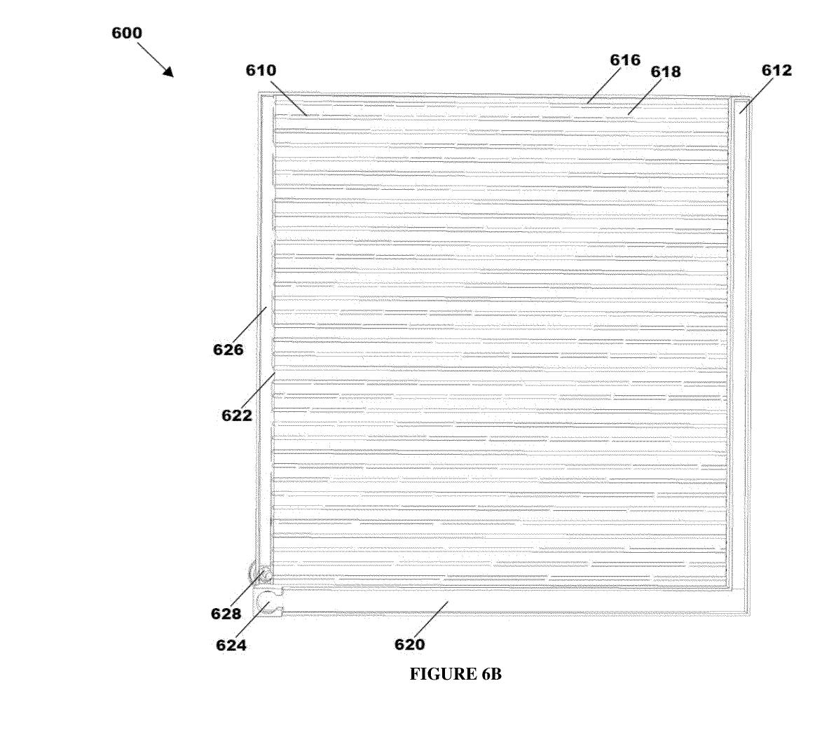

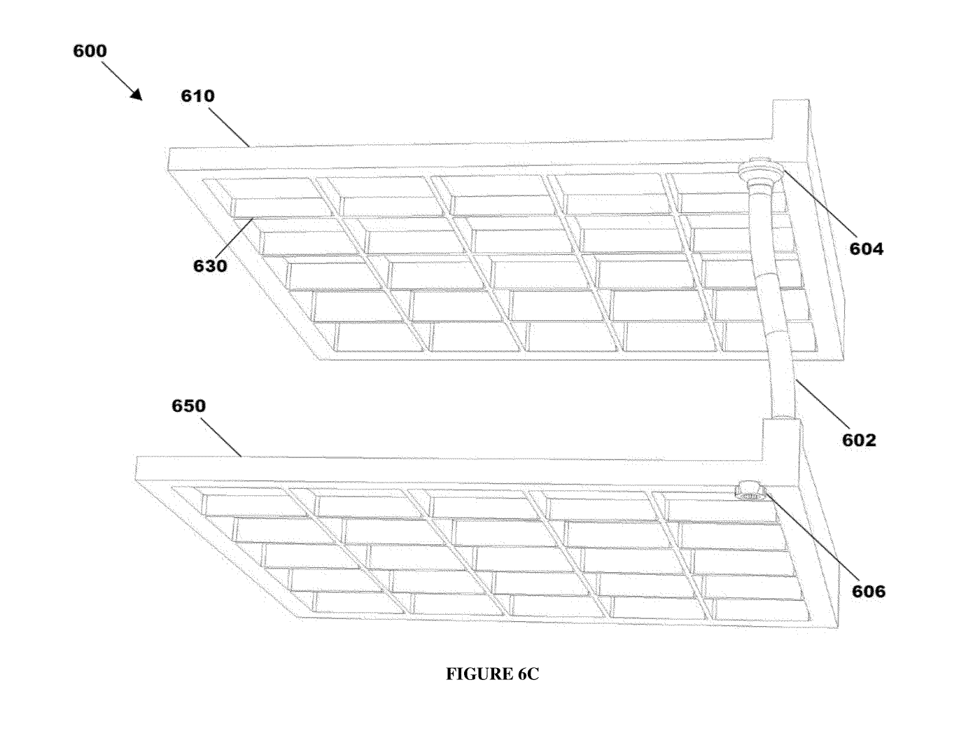

FIG. 6A illustrates a perspective view of one example of a pair 600 of supporting trays 610 and 650. The pair 600 of supporting trays of FIG. 6A is similar to the pair 500 of supporting trays described above. FIG. 6A includes a feeding channel 612 that feeds liquid nutrient through apertures 614. The apertures feed the liquid to channels 618 defined by ribs 616 on the upper surface of the supporting tray. The liquid nutrient falls off a front edge 622 into a front channel 626 (see FIG. 6B), from where it is routed to an aperture 628 (FIG. 6B) and a tubular channel 602.

Upper supporting tray 610 includes an aperture 624 to receive liquid nutrient from another supporting tray above or directly from a liquid nutrient supply manifold. The liquid nutrient is fed from aperture 624 to a side channel 620, which feeds the liquid nutrient to the feeding channel 612. When the liquid nutrient falls over front edge 622, it is collected in front channel 626. From there, it flows to an aperture 628 that feeds the tubular channel 602.

By reducing the number of side channels, upper supporting tray 610 may reduce the width of the tray (or provide more growing space). Although apertures 624 and 628 are shown in a front right portion of the supporting tray, the apertures could be located in any location on the perimeter. Further, although apertures 624 and 628 are located in similar locations, some supporting trays may include apertures in different positions. For example, the arrangement of upper supporting tray 610 could be used with the arrangement of lower supporting tray 550 if aperture 628 were relocated to the rear of the supporting tray 610.

FIG. 6B illustrates a top view of the arrangement of FIG. 6A (note that lower supporting tray 650 is obscured by upper supporting tray 610). Clearly visible in FIG. 6B is the front channel 626 and rear channel 612.

FIG. 6C illustrates an underside view of the arrangement of FIG. 6A. The underneath of each supporting tray may be configured to provide a stable base but also to reduce the weight of the platform. For example, the underside of upper supporting tray 610 is constructed of spines 630 that provide lightweight stability for the supporting tray.

Tubular channel 602 may include a connector 604 at the upper edge for connecting the channel to the supporting tray. A corresponding connector 606 can be seen on the bottom of lower supporting tray 650.

As noted, the platform may be sloped so that the liquid nutrient may flow from the back to the front of the upper surface. Channels or lower surfaces may also be sloped from the front to the back of the lower tray. In some embodiments, the slopes are predetermined to achieve optimal flow rate, velocity and/or volume of the liquid nutrient. For example, the slopes may be about 0.5, 1, 1.5, 2, 3, 5, 10, 15, 20, 25, 30 or more degrees to the horizontal. In some, the slopes are within a range of 1.5-2 degrees to the horizontal. In some embodiments, the upper tray and the lower tray may have different slopes to enhance plant growth.

As described above, some platforms may comprise channels that drive nutrient flow patterns to enhance plant growth. Some channels may be defined by ribs on the surface of the tray. In some embodiments, the ribs prevent the fine hairs on the plant roots from creating a water block. In some embodiments, the ribs may comprise rounded corners that reduce damage to the roots of a plant.

Oxygenation of the liquid nutrient may be progressively increased during flow from the top platform to the bottom platform. In some embodiments, the liquid nutrient has an oxygen concentration of at least about 8, 9, 10, 11 or 12 ppm. Without being bound by a theory, the present disclosure contemplates embodiments that improve turbulence of the liquid nutrient for the purpose of increasing oxygenation. For example, turbulences occur when the laminar flow leaves the upper platform, at the intersection of the connecting channel and the waterfall, the intersection of the upper tray and the lower tray, the intersection of the lower tray and the waterfall, and/or at the bottom of the waterfall. In some embodiments, the trays and/or the waterfall incorporate materials and/or physical features, such as ribs, ridges, intrusions, depressions, etc., that increase turbulence and/or reduce splashing. In some variations, the rate of dissolved oxygen (“d.o.”) increase is configured to matches the rate of oxygen consumption of plants. This rate of d.o. increase may vary from pod to pod, platform to platform, or growth-stage to growth-stage. In some variations, the rate of d.o. increase is matched to an expected highest rate of oxygen consumption. In some further variations, the rate of d.o. increases is approximately 0.5 ppm/shelf.

In some embodiments, the trays and/or the waterfall incorporate materials and/or physical features that allow a Nutrient Film Technique to be used for plant cultivation. In some embodiments, the trays and/or the waterfall incorporate materials and/or physical features, such as ridges, intrusions, depressions, etc., that generate laminar flow over the plant roots. In some embodiments, the trays and/or the waterfall may incorporate rubber mats to produce a wicking effect, e.g., for seeding. Embodiments that maximize flow efficiency over the roots of the plants, which may vary for different plants depending on their roots, are contemplated. Anti-algae chemical additives, such as silver, dark environment, and/or physical features, such as sharp objects, are also desirable.

### Lighting System

LEDs may be used to provide lighting to plants within the pods. The LEDs may be spatially distributed to provide a planar wavefront of constant intensity at a predetermined distance from the LEDs. The planar wavefront of constant intensity may provide the same density of photons across the wavefront and the same density as the wavefront travels beyond the predetermined distance. That is, as the wavefront progresses away from the LEDs, the intensity of light remains constant beyond the predetermined distance.

With this spatial distribution of LEDs, each plant in the plant carrier can receive equal intensity of light. This improves the possibility of a consistent harvest. Further, uniform intensity as the wavefront travels ensures that a plant receives the same light source at all stages of growth. That is, as the plant grows toward the LEDs, it receives constant photon density throughout its growth. In this way, the lighting system or platform need not be repositioned as the plant grows, further reducing the labor costs and simplifying automation.

The LED distribution may also be configured to produce the uniform wavelength at a reduced distance from the LED location. This reduces the minimum distance required between the LEDs and the plant carriers. By reducing the required minimum distance between the LEDs and the plant carriers, the distance between platforms can be reduced. This reduces the overall height of the cultivation pods, again saving on fabrication costs and storage area.

In some pods, the internal space includes reflective surfaces to increase the efficiency of light use. By increasing the efficiency of light produced, less energy is required to sustain cultivation in the pod. A reflective surface may be a minor or a polished white interior wall, door, window, ceiling, platform, or floor. In some further embodiments, the reflective surface may comprise a coating, such as Mylar®, on one or more of the wall, door, ceiling, platform, or floor. When creating a planar wavefront, the spatial distribution of LEDs may account for the light reflected from reflective surfaces.

In some examples, the LEDs are arranged in a substantially planar orientation directly above one platform and below another platform. The LEDs may comprise a part of the platform, or be inserted into the platform. The substantially planar orientation may be generally orthogonal to the orientation of a reflective surface.

As described above, the LEDs may be spatially distributed to provide a planar wavefront of constant intensity. The spatial distribution may comprise a non-linear distribution in one or more dimensions. In other words, the unevenly distributed LEDs may be gathered in distinct regions. Regions that are closer to a boundary structure or a reflective surface may be more densely spaced. By varying the density of LEDs, the cultivation pod may beneficially distribute light uniformly.

The arrangement of LEDs may be configured so that light from the LEDs constructively interferes to produce a planar wavefront at a predetermined distance from the LEDs. The predetermined distance may be 18 inches.

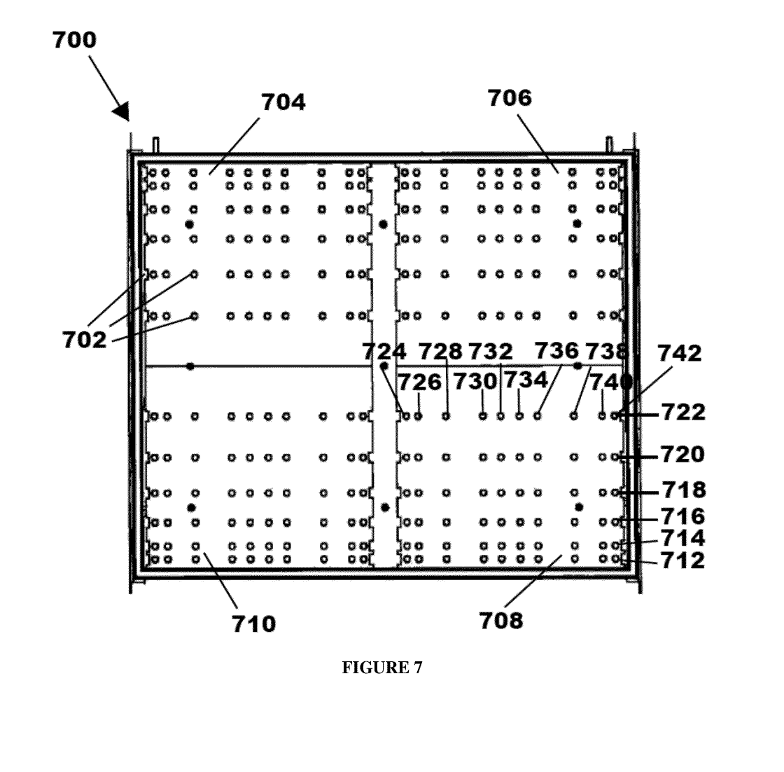

FIG. 7 illustrates an exemplary arrangement 700 of LEDs 702 in a substantially planar orientation. The LEDs 702 are arranged in a grid like pattern—that is, rows and columns of LEDs. The LEDs 702 are arranged in four quadrants 704, 706, 708, and 710. The arrangement within each quadrant is similar. The lower right quadrant 708 will now be discussed in detail, but it should be understood that the other quadrants may take the same or a different configuration. Quadrant 708 contains six rows and ten columns, for a total of 60 LEDs. In some embodiments, the positioning of the rows is characterized as a percentage of the depth of the quadrant, wherein the depth of a quadrant is taken in a direction from the front to the back of the pod. In quadrant 708, the first row 712 is positioned at 5% of the depth, the second row 714 is positioned at 14% of the depth, the third row 716 is positioned at 25% of the depth, the fourth row 718 is positioned at 40% of the depth, the fifth row 720 is positioned at 55% of the depth, and the sixth row 722 is positioned at 72% of the depth. In some embodiments, the positioning of the columns is characterized as a percentage of the width of the quadrant, wherein the width of a quadrant is taken in a direction from side to side of the pod. In quadrant 708, the first column 724 is positioned at 4% of the width, the second column 726 is positioned at 10% of the width, the third column 728 is positioned at 23% of the width, the fourth column 730 is positioned at 38% of the width, the fifth column 732 is positioned at 45% of the width, the sixth column 734 is positioned at 55% of the width, the seventh column 736 is positioned at 62% of the width, the eighth column 738 is positioned at 77% of the width, the ninth column 740 is positioned at 90% of the width, and the tenth column 742 is positioned at 96% of the width.

The LEDs may be arranged in the shape of a grid, where some nodes on the grid do not contain an LED to thereby create regions of differing LED density. In some embodiments, the LEDs are arranged in concentric circles about a central point, where some angles and radii do not contain an LED to thereby create regions of differing LED density.

In some pods, the LEDs associated with a first platform are arranged differently from the LEDs associated with a second platform. In this way, the cultivation pod may beneficially be configured to include a multitude of planar wavefronts to accommodate different plant varieties or different growth stages on different platforms within the same pod.

The number of LEDs may be partially determined by a voltage requirement, such as a UL (Underwriter's Laboratory) standard. In some embodiments, the arrangement of the LEDs is partially determined by the spacing available on a printed circuit board. The plurality of LEDs may be interconnected so that failure of a predetermined number of LEDs will not result in failure of all LEDs.

In some embodiments, a plurality of LEDs of the light distribution system comprises a plurality of red LEDs and a plurality of blue LEDs. The number of red and blue LEDs may be the same or different. In some embodiments, the plurality of red LEDs and the plurality of blue LED are in a ratio of 4 red LEDs to each blue LED. In some embodiments, a light distribution controller is configured to selectively activate one or more of the plurality of LEDs, wherein the light distribution controller is further configured to adjust a ratio of active red LEDs to active blue LEDs. In some further embodiments, a light distribution system comprises one or more multi-color LEDs (RGB LEDs) to provide precise dynamic color control. Such multi-color LEDs may provide a variety of colors and, hence, wavelengths.

In some embodiments, a plurality of LEDs of the light distribution system comprises a plurality of red LEDs, a plurality of blue LEDs, a plurality of royal blue LEDs, and a plurality of white LEDs. This embodiment may beneficially encourage plant growth at an early growth-stage. In some embodiments the plurality of red LEDs, the plurality of white LEDs, the plurality of blue LEDs, and the plurality of royal blue LED are in a ratio of 6 red LEDs to 2 white LEDs to 1 blue LED to 0.5 royal blue LEDs. In some embodiments, a light distribution controller is configured to selectively activate one or more of the plurality of LEDs, wherein the light distribution controller is further configured to adjust a ratio of active red LEDs to active white LEDs to active blue LEDs to active royal blue LEDs.

In some embodiments, a light distribution controller is configured to adjust the wavelength of the distributed light. The wavelength may be adjusted to match growth preferences of different plants or different growth-stages of a particular plant.

In some embodiments, the LEDs associated with a first platform are arranged differently from the LEDs associated with a second platform. In this way, the cultivation pod may beneficially be configured to include a multitude of LED colors and wavelengths to accommodate different plant varieties or different growth stages on different platforms within the same pod.

Although described above primarily with respect to LEDs, other point light sources could be used. For example, a natural-light fiber optic system is described below. An artificial fiber optic lighting system could also be used. Some embodiments may use other light sources.

In some embodiments, the light distribution system comprises natural light, that is, light provided by an external light source, such as the sun or a warehouse lighting system, for example. The natural light may be used to augment or replace an artificial light system in the pod.

In an embodiment where the cultivation pod has no or a transparent ceiling, the light distribution system may further comprise a pod positioning system, wherein the pod positioning system is configured to reposition the pod in accordance with movement of an external source of light, such as the sun, for example. In this way, the pod may provide a planar wavefront to the plants throughout the day.

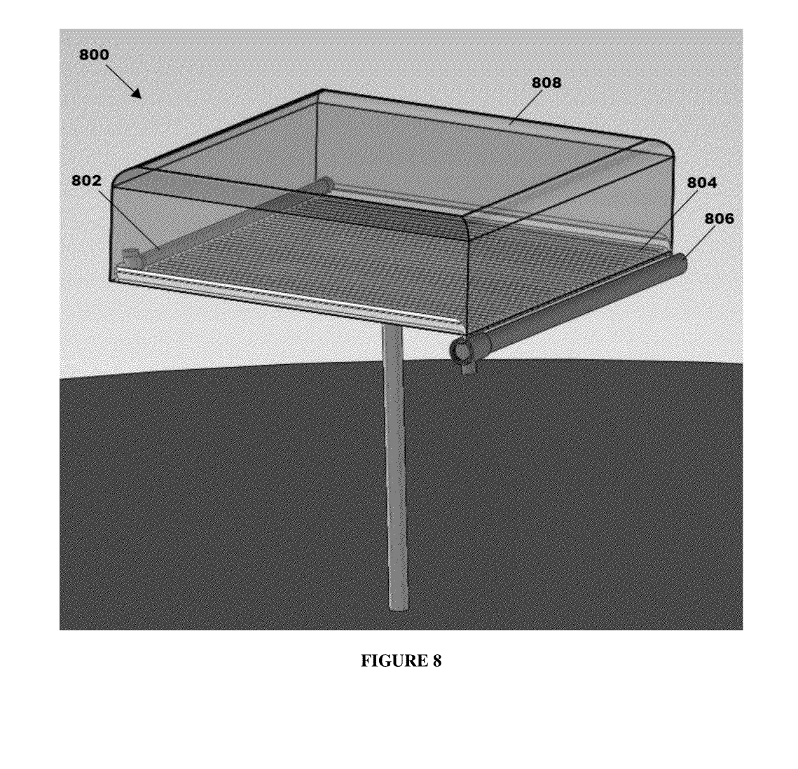

An exemplary “transparent ceiling” cultivation pod 800 is illustrated in FIG. 8. Cultivation pod 800 may include a feeding tube 802, a supporting tray 804, and a front channel 806. The platform of cultivation pod 800 may have similar features as other platforms described above. A plant carrier (not shown) may be placed on top of supporting tray 804 and liquid nutrient passed over the supporting tray to feed roots of plants positioned on the plant carrier. In cultivation pod 800, a transparent dome 808 is placed over the platform. This may allow light to feed plants on the platform, while also keeping pests from the plants. In some variations, no air distribution system or light distribution system is included, and natural air and sun light may be used for plant cultivation.

In some embodiments, a light distribution system of a cultivation pod comprises a lighting cooling system configured to reduce the temperature of electronics associated with the light distribution system.

In some embodiments, the cooling system comprises distilled water circulated in tubing, wherein the distilled water absorbs heat emitted from the electronics. Using distilled water, rather than a chemical heat exchange medium, may prevent contamination of the plants in the event of a failure. In some embodiments, the cooling system is monitored for failure by monitoring one or more of the temperatures of the light source or the pressure in the cooling system. In some further embodiments the cooling system comprises a heat exchanger to reduce the temperature of the distilled water, wherein energy extracted from the water is discarded or reused in the system. This may beneficially reduce the consumption of energy by the system.

In some embodiments, the cooling system comprises an air circulation system configured to pass air over the electronics. In some further embodiments, the cooling system further comprises a heat exchanger to reduce the temperature of circulated air, wherein energy extracted from the circulated air is discarded or reused in the system. This may beneficially reduce the consumption of energy by the system.

In some embodiments, the pod may include a heat shield between the electronics and the platform. In some further embodiments, the heat shield comprises a Mylar coating.

In some embodiments, the light distribution system comprises a fiber optic system configured to channel external light to the internal space of the cultivation pod. In some further embodiments, the fiber optic system further comprises a Fresnel lens configured to separate visible light from infrared light. The Fresnel lens may focus the visible light and infrared light at different focal points, allowing for separation of the two wavelengths. In yet further embodiments, the fiber optic system further comprises a first channel for channeling the visible light to the internal space of the cultivation pod and a second channel for channeling the infrared light away from the internal space of the cultivation pod. This structure may beneficially prevent raising the temperature inside of the cultivation pod (infra-red light) while still introducing photons to the pod. In further embodiments, the second channel channels the infrared light to an energy recuperation system. This may beneficially reduce the consumption of energy by the system.

In some further embodiments, a prism, or other device for separating light in constituent wavelengths, may be used to extract one or more desired colors of light. In yet further embodiments, the different color light is provided to the cultivation in the ratios of the LEDs of an artificial light distribution system. For example, the red and blue wavelengths of external light may be separated and channeled into the cultivation pod so that the red and blue light are in the ratio of 4:1. The remaining wavelengths of light are channeled to an energy recuperation system. In some embodiments, the wavelength separation occurs before the visible light is separated from the infra-red. In other embodiments, the wavelength separation occurs after the visible light is separated from the infrared. In yet other embodiments, the wavelength separation and infra-red separation occurs at the same time.

### Air Distribution System

The air distribution system may include a pressurized air flow into the internal space of the cultivation pod. The air distribution system provides a source of carbon dioxide for the plants' photosynthesis process.

In nature, plants receive carbon dioxide from the ambient air. Pressure gradients circulate the ambient air (“wind”) allowing the air to reach under the leaves of the plant. This is important to plant growth because plants may absorb most of their carbon dioxide through the under-side of the leaf.

In some pods, the air distribution system introduces air to the underside of the plants at a given stage of growth. To that end, the holes may be positioned at a predetermined distance above the plant carrier surface. The distance may be chosen so that the air feeds the underside of the plants when the plants have combined to create a substantially continuous canopy, for example. Exemplary heights may include 0.1 meters. In some variations, the height may be between 0.05 to 0.45 meters.

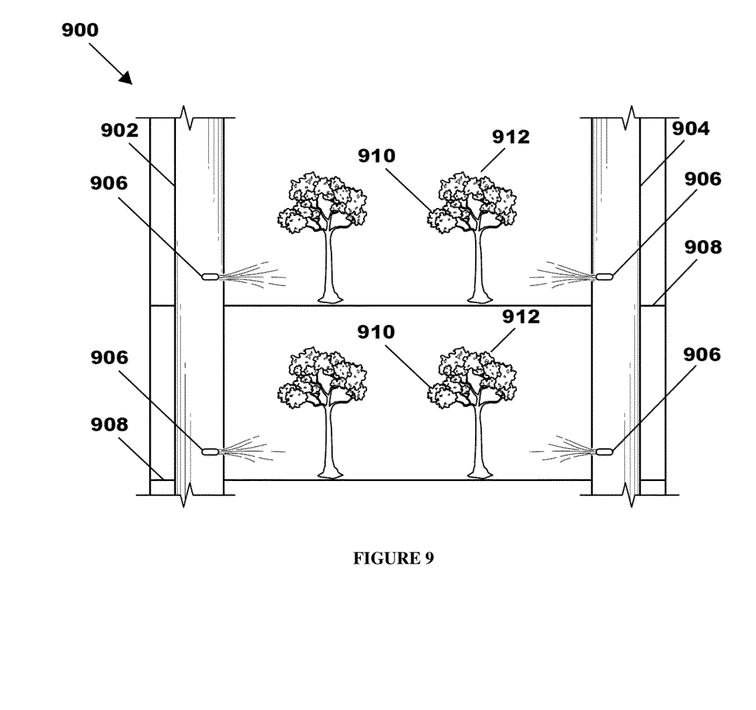

FIG. 9 illustrates a cultivation pod 900 with an exemplary air distribution system having vertical bellows 902 and 904. The bellows have holes 906 positioned slightly above the plant carriers 908 to get under the leaves 910 of the plants 912. The holes are also positioned so that a radial air flow is generated. The bellows may be a collapsible air sleeve so that it does not interfere with access to the interior of the pod. One or more bellows may be used. As illustrated in FIG. 9, the bellows may be located in a corner (or along a side) of the cultivation pod, to avoid interference with removal of a plant carrier.

In some pods, the holes are positioned between 0.05 and 45 centimeters above the height of the plant carrier. For some bellows, the height may be 0.1, 0.5, 1, 5, 10, 15, 20, 25, 30, 35, or 40 centimeters above the height of the pod. In some pods, the height of the holes above the plant carrier is other than those listed here.

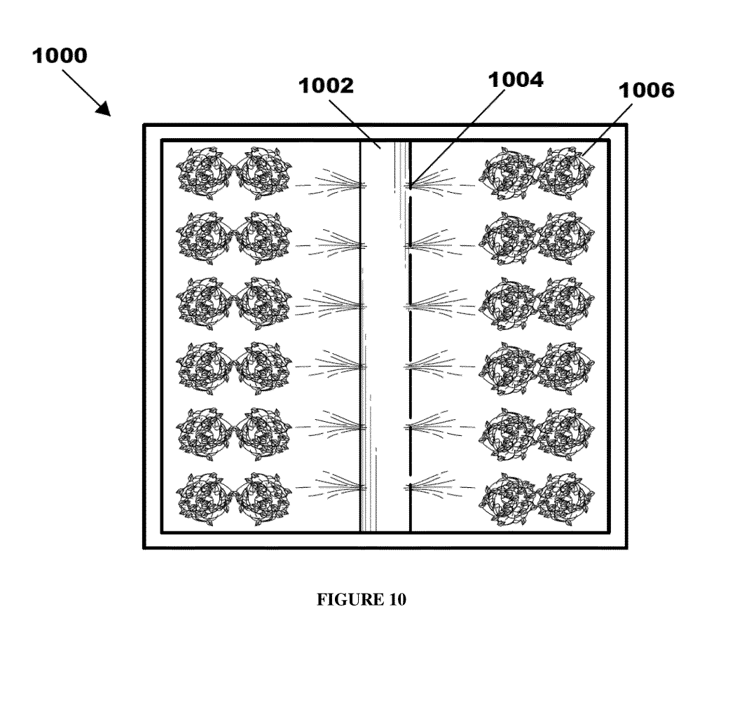

FIG. 10 illustrates a cultivation pod 1000 with an exemplary air distribution system with horizontal bellows 1002. The horizontal bellows are positioned near to the surface of the plant carriers and have holes 1004 therein to feed air to the plants 1006. The horizontal bellows may be positioned so that they do not interfere with the removal of plant carriers from the cultivation pod.

Any suitable bellows may be, but are limited to, air sleeves, pressurized manifolds, and vertical/horizontal air tubes. The air flow may be increased according to density of plants and/or need of plant growth, inhibition of fungus, mold, etc.

In some embodiments, the air distribution system may comprise an air filter, e.g., a sub-micro High-Efficiency Particulate Air (HEPA) filter, in order to remove or reduce particulate contamination, pathogen and/or pest infiltration from the outside environment. Embodiments of the air distribution system that provide additional CO₂ to enhance plant growth, e.g., CO₂ additives, are also contemplated for the current disclosure.

In some pods, the internal space is insulated from the outside environment. In some embodiments, a positive air pressure may be maintained inside the cultivation pod to improve insulation of the internal environment of the cultivation pod. Further, a mechanism to improve air flow may be used, such as a fan, to fan out/wind in air and/or increase air circulation. Thermal control of the outside air coming into the cultivation pod may also be integrated into the air distribution system.

Alternatively, the cultivation pod may use an open air distribution system, wherein the outside air is directly connected to the internal atmosphere of the cultivation pod. These embodiments may be used, for example, when the cultivation pod is being used in a warehouse, wherein the air flow of the warehouse is controlled by a warehouse-wide air distribution system. These embodiments may also be used the cultivation pod is located in a non-warehouse or open-air setting.

In some embodiments, sound waves may be used for pollination of flowering plants. In some embodiments, the frequency of the sound wave may be about 0-2,000 Hz. Typically, the frequency of the sound wave may be about 210-260 Hz.

### Nutrient Distribution Systems

The liquid nutrient distribution system supplies needed nutrients to the plants being cultivated. In some pods, the liquid nutrient distribution system may comprise a nutrient delivery manifold and/or a nutrient reservoir. In some pods, the nutrient delivery manifold may be located at the top of the platform(s), while the nutrient reservoir may be located at the bottom. In some embodiments, the liquid nutrient distribution system may comprise a plurality of reservoirs for the liquid nutrient located on each platform. In some embodiments, the nutrient reservoir may be located outside of the cultivation pod, and may feed more than one cultivation pod, for example, all of the cultivation pods in an automated plant cultivation system as described below. In some embodiments, the liquid nutrient may be periodically replenished from a master supply, preferably controlled by a computer program.

In some embodiments, additional mechanisms may be included to modify the flow rates of the liquid nutrient, e.g., a pump, etc. In some embodiments, the liquid nutrient may flow continuously. In some embodiments, the liquid nutrient may flow intermittently. A computer program may be used to control the flow rate of the liquid nutrient. According to the different plant species being cultivated and/or different time points in the growth cycle, the flow rate may be adjusted to achieve maximum growth of the plants. In some embodiments, the flow rate may be 1-3 liters/minute per row of plants.

In some embodiments, the liquid nutrient may be adjusted for, e.g., temperature, pH, oxygenation, etc. According to the different plant species being cultivated and/or different time points in the growth cycle, the temperature, pH, and/or oxygenation may be adjusted to enhance growth of the plants. In some embodiments, no soil is used for the cultivation of plants. In some embodiments, soil is used for the cultivation of plants. In some embodiments, the oxygenation level of the liquid nutrient may be adjusted to suit the growth condition of the plant, for example, by adjusting the height of the waterfall, materials used for the tray and/or the ribs, etc. Automated System for Plant Cultivation

### Automated System for Plant Cultivation

The automated system may include a computer system for controlling and monitoring an environmental parameter such as temperature, lighting, humidity, flow rate, wind speed, nutrient and/or pH level of the liquid nutrient, etc.

In some embodiments, the automated system may further comprise a monitoring system to inspect plant growth and/or contamination with mold, algae, etc. Any suitable monitoring device may be used, e.g., a camera, a ruler, a video camera, etc. Visual inspection may also be used for growth confirmation. The visual or camera inspection of the interior of the pod may be enhanced by a scaling mechanism, for example, a ruler. In some embodiments, an automatic sensor system—such as a LIDAR (Light Detection And Ranging, also LADAR) system—may be used to determine the height of plant growth without human intervention. In some embodiments, image analysis may be used to determine plant growth, such as the height or volume of a plant. In some embodiments, height and/or color analysis may be used to deduce efficacy of nutrient ratios. In some embodiments, the analysis and resulting actions are carried out by an automated system, that is, based on the color analysis, for example, the nutrient content may be altered.

An automated plant cultivation system of the present disclosure may comprise at least 1, 2, 3, 4, 5, 10, 100, or more of the cultivation pods disclosed herein. In some embodiments, the automated system may comprise a transferring system, e.g., a conveyor belt, that moves the cultivation pods for specific manipulations, such as seeding, harvesting, etc. In some embodiments, the automated system further comprises an automatic platform distribution system. In some embodiments, the automatic platform distribution system comprises a robotic arm that removes and/or replaces the plant carrier and/or the supporting trays.

The automated plant cultivation system may further comprise a central control system to monitor and control the environmental parameters of the cultivation pods such as temperature, lighting, humidity, flow rate, wind speed, nutrient and/or pH level of the liquid nutrient, etc. The central control system may comprise devices and computer programs that monitor and adjust a variety of environmental parameters of individual cultivation pods. Individual cultivation pods of the automated system may have the same or different environmental parameters. In embodiments where the cultivation pods have the same environmental parameters, they may be arranged in a warehouse setting, so that the control system may monitor and control the environmental parameters of the entire warehouse. In some embodiments, one point for sampling and adjustments may be used for individual pods, or individual platforms. In some embodiments, plant growth data from the monitoring system may be used to adjust environmental parameters to enhance plant growth.

Environmental parameters of a cultivation pod may be used to simulate certain weather and/or climate conditions in order to produce a certain species of plant, accentuate certain qualities of a plant, or produce a certain flavor of the plant. Therefore, an automated system of the present disclosure may comprise a plurality of cultivation pods that produce a variety of plant species with a variety of accentuated attributes, and/or a variety of flavors of a plant species. To enhance plant growth, environmental parameters, e.g., temperature, lighting, humidity, flow rate, wind speed, nutrient and/or pH level of the liquid nutrient, growth or fungi, bacteria, algae, etc., of a cultivation pod may also be varied according to the need of the plants during different periods of their growth cycle.

In one method for cultivating a plant, a plant is grown in a cultivation pod described herein. In some methods, a plant carrier is removed from a cultivation pod in a plane, wherein the plant carrier lies in the plane when positioned on a supporting tray during plant growth. In another method, a plant carrier is removed from a cultivation pod without removing a supporting tray from the pod. Some methods allow a plant carrier to be removed from a cultivation pod without disconnecting a nutrient supply system.

In some methods of illuminating a cultivation pod, LEDs are arranged in a planar orientation in the pod and are unevenly distributed in the substantially planar orientation. The LEDs may be configured to provide a uniform wavefront at a predetermined distance from the LEDs.

In some methods of distributing air in a cultivation pod, vertical bellows are arranged to provide air to the underside of plants positioned within the pod. In some further methods, holes are located in the bellows at a predetermined height above a plant carrier.

Some methods of manufacturing a cultivation pod may include constructing any of the cultivation pods herein.

### Seeding System

In some embodiments, the automated plant cultivation system further comprises a seeding system. The seeding system may comprise devices and computer programs that automatically plant seed at appropriate positions in the plant carrier. In some embodiments, pelletization may be used to prepare the seeds for plantation. In some embodiments, raw seeds may be used for plantation. For automated seeding, seeds may be mixed with liquid, gel or solid materials to improve handling.

A tracking system is also contemplated to trace a plant through the entire cultivation process. For example, a plant may be identified from seed to packaging, or to the point of sale to the end user, using a unique identifier, such as a bar code, a radio-frequency identification (RFID) tag, etc. In some embodiments, the unique identifier may be used to record all the information in regard to the cultivation of the plant, such as species, time, location, environmental parameters used, etc.

As used herein, to “enhance growth” of a plant refers to the practice of adjusting the growth conditions to achieve a higher yield of a plant for a given time and/or a given cost. The yield of a plant may be measured, for example, as biomass per unit time, per volume, and/or per plant. The cost for plant cultivation may be measured, for example, as the cost of energy, nutrient, water, oxygen, CO₂, manpower, etc., or a combination thereof.

All publications, including patent documents and scientific articles, referred to in this application and the bibliography and attachments are incorporated by reference in their entirety for all purposes to the same extent as if each individual publication were individually incorporated by reference.

Citation of the above publications or documents is not intended as an admission that any of the foregoing is pertinent prior art, nor does it constitute any admission as to the contents or date of these publications or documents.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention. The various embodiments of the invention should be understood that they have been presented by way of example only, and not by way of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the invention, whether or not such embodiments are described, and whether or not such features are presented as being a part of a described embodiment. Thus the breadth and scope of the invention should not be limited by any of the above-described exemplary embodiments.

Terms and phrases used in this document, and embodiments thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Unless defined otherwise, all technical and scientific terms used herein have the same meaning as is commonly understood by one of ordinary skill in the art to which this invention belongs. All patents, applications, published applications and other publications referred to herein are incorporated by reference in their entireties. If a definition set forth in this section is contrary to or otherwise inconsistent with a definition set forth in the patents, applications, published applications and other publications that are herein incorporated by reference, the definition set forth in this section prevails over the definition that is incorporated herein by reference.

1. A cultivation pod, comprising:
a platform within the pod, wherein the platform comprises
a supporting tray comprising a plurality of channels, each channel having a nutrient-film, and
a plant carrier positioned on the supporting tray, wherein the plant carrier lies in a plane when positioned on the supporting tray and is removable in a direction that lies in the plane without removing the supporting tray from the pod;
a nutrient supply system that feeds nutrient media to the supporting tray, wherein the plant carrier is removable from the pod without disconnecting the nutrient supply system from the supporting tray; and
a plurality of light-emitting diodes (LEDs) that provide light to the plant carrier when the plant carrier is positioned on the supporting tray, wherein the LEDs lie in a planar orientation and are unevenly distributed in the substantially planar orientation.

2. The cultivation pod of claim 1, further comprising a vertical bellows that feeds air radially into the cultivation pod.

3. The cultivation pod of claim 2, wherein the vertical bellows creates a planar air flow.

4. The cultivation pod of claim 2, wherein the vertical bellows comprises a plurality of holes, the holes positioned less than or equal to 0.05 to 45 centimeters above a top of the plant carrier when the plant carrier is on the supporting tray.

5. The cultivation pod of claim 1, wherein each channel is defined by a pair of ribs and a height of each rib above a bottom of the channel is less than or equal to 0.65 centimeters above an upper surface of the supporting tray.

6. The cultivation pod of claim 1, wherein the nutrient supply system feeds nutrient media to a rear portion of the supporting tray, the nutrient media flows along an upper surface of the supporting tray to provide the nutrient film, and falls vertically from a front portion of the supporting tray.

7. The cultivation pod of claim 6, wherein the nutrient media flows from the front portion of the supporting tray to a rear portion of the supporting tray.

8. The cultivation pod of claim 7, wherein the nutrient media flows on a lower surface of the supporting tray when the nutrient media flows from the front portion of the supporting tray to the rear portion of the supporting tray.

9. The cultivation pod of claim 1, wherein the supporting tray comprises a front edge that permits removal of the plant carrier in the plane.

10. The cultivation pod of claim 1, wherein the plant carrier has a surface area comprising substantially equal width and length.

11. The cultivation pod of claim 1, further comprising reflective surfaces in an internal space of the cultivation pod.
